(19) United States
(12) Patent Application Publication
(10) Pub. No.: US 2024/0343857 A1
(43) Pub. Date: Oct. 17, 2024

(54) EXTRUDABLE POLYURETHANE ARTICLES AND COMPOSITIONS AND METHODS OF MAKING AND PRINTING SAME

(71) Applicant: 3M INNOVATIVE PROPERTIES COMPANY, St. Paul, MN (US)

(72) Inventors: Joseph D. Rule, Woodbury, MN (US); Kolby L. White, Woodbury, MN (US); Ross E. Behling, Woodbury, MN (US); Jacob D. Young, St. Paul, MN (US); Jay M. Jennen, Forest Lake, MN (US); David P. Siglin, St. Paul, MN (US)

(21) Appl. No.: 18/294,184

(22) PCT Filed: Aug. 15, 2022
(86) PCT No.: PCT/IB2022/057632

§ 371 Date: Feb. 1, 2024

Related U.S. Application Data
(60) Provisional application No. 63/251,782, filed on Oct. 4, 2021.

(51) Int. Cl. C08G 18/72; B29C 48/00; B29C 48/05; B29C 64/118; B29K 75/00; B29K 105/00; B29L 31/00; B33Y 10/00; B33Y 70/00; C08G 18/28; C08G 18/42; C08G 18/65; C08G 18/66; C08G 18/76; C08G 18/79; C09D 175/06

(52) U.S. Cl. CPC C08G 18/725; B33Y 70/00; C08G 18/2825; C08G 18/4238; C08G 18/6511; C08G 18/664; C08G 18/7671; C08G 18/798; C09D 175/06; B29C 48/022; B29C 48/05; B29C 64/118; B29K 2075/00; B29K 2105/0088; B29L 2031/731; B33Y 10/00

(57) ABSTRACT

The present disclosure provides an extrudable article and a composition, each including at least one polyurethane including hydroxyl groups and latent isocyanate groups in the form of uretdione groups. The hydroxyl groups are present on a first polyurethane and the latent isocyanate groups are present on either the first polyurethane or a second polyurethane and a ratio of the latent isocyanate groups to the hydroxyl groups is greater than 1.2:1. A method of making the extrudable article is provided including reacting in an extruder a polymerizable composition including a uretdione-containing material including a reaction product of a diisocyanate reacted with itself, a hydroxyl-containing compound, and an isocyanate-containing compound. A method of making a core-sheath filament is provided including forming a core composition of the at least one polyurethane and wrapping a sheath composition including an ethylene copolymer or a polyolefin around the core composition. Further, methods of printing a composition are provided including heating and mixing the extrudable article, such as in an extruder, to form a molten composition, then dispensing the molten composition through a nozzle onto a substrate.

### FIELD

The present disclosure generally relates to the field of polyurethane compositions.

### BACKGROUND

Hotmelt polyurethane adhesives are often grouped as non-reactive or reactive. The polymer chains in reactive polyurethane adhesives have isocyanate end groups, and they tend to have relatively lower molecular weights. After application to the final substrates, ambient moisture reacts with the isocyanate end groups, which leads to crosslinking of the adhesive and relatively high thermal stability. However, the isocyanate groups must be protected from ambient moisture during storage and processing, which makes reactive polyurethane adhesives less convenient to handle compared to polyurethane adhesives that have non-reactive end groups, such as alcohol groups. Non-reactive polyurethane adhesives flow when reheated to temperatures near their original application temperature; however, they tend to have the disadvantage of a limited range of use temperatures.

### BRIEF DESCRIPTION OF DRAWINGS

FIG. 1A is a schematic perspective exploded view of a section of a core-sheath filament, according to an embodiment of the present disclosure.

FIG. 1B is a schematic cross-sectional view of a core-sheath filament, according to an embodiment of the present disclosure

FIG. 2A is a schematic side view of an exemplary extrudable article having the shape of a ribbon according to some embodiments of the present disclosure.

FIG. 2B is a schematic end view of the exemplary extrudable article of FIG. 2A.

FIG. 3 is a schematic perspective view of an exemplary extrudable article having a shape of a filament and wrapped around a spool, according to some embodiments of the present disclosure.

FIG. 4 is a schematic side view of an exemplary extrudable article having a shape of a filament and provided as a festoon, according to some embodiments of the present disclosure.

FIG. 5 is a schematic perspective view of an exemplary extrudable article having a shape of a filament and hermetically sealed in a package with a desiccant.

FIG. 6 is a schematic cross-sectional view of an exemplary article including two substrates adhered together, preparable according to the present disclosure.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### SUMMARY

In a first aspect, an extrudable article is provided. The extrudable article comprises at least one polyurethane comprising hydroxyl groups and latent isocyanate groups in the form of uretdione groups, wherein the hydroxyl groups are present on a first polyurethane and the latent isocyanate groups are present on either the first polyurethane or a second polyurethane, wherein a ratio of the latent isocyanate groups to the hydroxyl groups is greater than 1.2:1.

In a second aspect, a composition is provided. The composition comprises at least one polyurethane comprising hydroxyl groups and latent isocyanate groups in the form of uretdione groups, wherein the hydroxyl groups are present on a first polyurethane and the latent isocyanate groups are present on either the first polyurethane or a second polyurethane, wherein a ratio of the latent isocyanate groups to the hydroxyl groups is greater than 1.2:1.

In a third aspect, a method of making a core-sheath filament is provided. The method comprises a) forming a core composition comprising at least one polyurethane comprising hydroxyl groups and latent isocyanate groups in the form of uretdione groups, wherein the hydroxyl groups are present on a first polyurethane and the latent isocyanate groups are present on either the first polyurethane or a second polyurethane, wherein a ratio of the latent isocyanate groups to the hydroxyl groups is greater than 1.2:1; b) forming a sheath composition comprising an ethylene copolymer or a polyolefin; and c) wrapping the sheath composition around the core composition to provide the core-sheath filament.

In a fourth aspect, a method of making an extrudable article is provided. The method comprises reacting in an extruder a polymerizable composition comprising i) a uretdione-containing material comprising a reaction product of a diisocyanate reacted with itself, ii) a hydroxyl-containing compound; and iii) an isocyanate-containing compound. The extrudable article comprises at least one polyurethane comprising hydroxyl groups and latent isocyanate groups in the form of uretdione groups, wherein the hydroxyl groups are present on a first polyurethane and the latent isocyanate groups are present on either the first polyurethane or a second polyurethane, wherein a ratio of the latent isocyanate groups to the hydroxyl groups is greater than 1.2:1.

In a fifth aspect, a method of printing a composition is provided. The method comprises a) feeding an extrudable article to an extruder, the extrudable article comprising at least one polyurethane comprising hydroxyl groups and latent isocyanate groups in the form of uretdione groups, wherein the hydroxyl groups are present on a first polyurethane and the latent isocyanate groups are present on either the first polyurethane or a second polyurethane, wherein a ratio of the isocyanate groups to the hydroxyl groups is greater than 1.2:1; b) heating and mixing the extrudable article in the extruder to form a molten composition; and c) dispensing the molten composition through a nozzle of the extruder onto a substrate.

In a sixth aspect, another method of printing a composition is provided. The method comprises a) heating and mixing an extrudable article to form a molten composition, the extrudable article comprising at least one polyurethane comprising hydroxyl groups and latent isocyanate groups in the form of uretdione groups, wherein the hydroxyl groups are present on a first polyurethane and the latent isocyanate groups are present on either the first polyurethane or a second polyurethane, wherein a ratio of the isocyanate groups to the hydroxyl groups is greater than 1.2:1; and b) dispensing the molten composition through a nozzle onto a substrate.

Articles and compositions according to at least certain embodiments of the present disclosure can be heated to cause the uretdione groups to substantially revert to isocyanate groups. The resulting isocyanate-terminated polyurethane forms a composition that can moisture cure to form covalent crosslinks and provide high thermal stability to the crosslinked polyurethane. As such, the articles and compositions tend to provide the convenience of non-reactive polyurethanes as well as the high performance of reactive polyurethanes.

### DETAILED DESCRIPTION

The terms “a”, “an”, “the”, “at least one”, and “one or more” are used interchangeably.

The term “and/or” means one or both such as in the expression A and/or B refers to A alone, B alone, or to both A and B.

The term “essentially” means 95% or more.

The term “equivalents” refers to the number of moles of a functional group (e.g., OH groups, isocyanate groups, uretdione groups, etc.) per molecule of a polymer chain or per mole of a different functional group.

The term “latent” with respect to functional groups refers to functional groups that are inactive or blocked.

The term “extrudable” refers to a material that is capable of being forced through an opening, such as the end of a nozzle.

The term “pellet” refers to a discrete solid mass of a material.

The term “ribbon” refers to an object that has an aspect ratio of length to longest cross-sectional distance (e.g., diameter) of 20:1 or greater and has a ratio of longest cross-sectional distance to shortest cross-sectional distance of 2:1 or greater.

The term “filament” refers to an object that has an aspect ratio of length to longest cross-sectional distance (e.g., diameter) of 20:1 or greater and a ratio of longest cross-sectional distance to shortest cross-sectional distance of less than 2:1.

The term “core-sheath filament” refers to a specific type of filament including a composition in which a first material (i.e., the core) is surrounded by a second material (i.e., the sheath) and the core and sheath have a common longitudinal axis. While the core and the sheath are typically concentric, the cross-sectional shape of the core can be any desired cross-sectional shape such as a circle, oval, square, rectangle, triangle, or the like. The ends of the core do not need to be surrounded by the sheath. The sheath surrounds the core in the core-sheath filament. In this context, “surround” (or similar words such as “surrounding”) means that the sheath composition covers the entire perimeter (i.e., the cross-sectional perimeter) of the core for a major portion (e.g., at least 80 percent or more, at least 85 percent or more, at least 90 percent or more, or at least 95 percent or more) of the length (the long axis direction) of the filament. Surrounding is typically meant to imply that all but perhaps the very ends of the filament have the core covered completely by the sheath.

As used herein, the term “non-tacky” refers to a material that passes a “Self-Adhesion Test”, in which the force required to peel the material apart from itself is at or less than a predetermined maximum threshold amount, without fracturing the material. The Self-Adhesion Test is described in co-owned PCT Publication No. WO 2021/028821 and is typically performed on a sample of the sheath material to determine whether the sheath is non-tacky.

As used herein, “melt flow index” or “MFI” refers to the amount of polymer that can be pushed through a die at a specified temperature using a specified weight. Melt flow index can be determined using ASTM D1238-13 at 190° C. and with a load (weight) of 2.16 kg. Some values for the melt flow index are available from vendors. Values can also be measured using Procedure A of the ASTM method. Vendor data is typically reported as having been determined using the same ASTM method as well as the same temperature and load.

The term “alkyl” refers to a monovalent radical of an alkane. Suitable alkyl groups can have up to 50 carbon atoms, up to 40 carbon atoms, up to 30 carbon atoms, up to 20 carbon atoms, up to 16 carbon atoms, up to 12 carbon atoms, up to 10 carbon atoms, up to 8 carbon atoms, up to 6 carbon atoms, up to 4 carbon atoms, or up to 3 carbon atoms. The alkyl groups can be linear, branched, cyclic, or a combination thereof. Linear alkyl groups often have 1 to 30 carbon atoms, 1 to 20 carbon atoms, 1 to 10 carbon atoms, 1 to 6 carbon atoms, or 1 to 4 carbon atoms. Branched alkyl groups often have 3 to 50 carbon atoms, 3 to 40 carbon atoms, 4 to 20 carbon atoms, 3 to 10 carbon atoms, or 3 to 6 carbon atoms. Cyclic alkyl groups often have 3 to 50 carbon atoms, 5 to 40 carbon atoms, 6 to 20 carbon atoms, 5 to 10 carbon atoms, or 6 to 10 carbon atoms.

The term “alkylene” refers to a divalent group that is a radical of an alkane. The alkylene can be straight-chained, branched, cyclic, or combinations thereof. The alkylene typically has 1 to 20 carbon atoms. In some embodiments, the alkylene contains 4 to 14 carbon atoms, 1 to 10 carbon atoms, 1 to 8 carbon atoms, 1 to 6 carbon atoms, or 1 to 4 carbon atoms. The radical centers of the alkylene can be on the same carbon atom (i.e., an alkylidene) or on different carbon atoms. In certain embodiments, the alkylene can be substituted with an OH group.

The term “hydroxyl group” means a monovalent group of formula —OH.

The term “isocyanate group” means a monovalent group of formula —N═C═O.

The term “alkane-triyl” refers to a trivalent radical of an alkane.

The term “aryl” refers to a monovalent group that is radical of an arene, which is a carbocyclic, aromatic compound. The aryl can have one to five rings that are connected to or fused to the aromatic ring. The other ring structures can be aromatic, non-aromatic, or combinations thereof. Examples of aryl groups include, but are not limited to, phenyl, biphenyl, terphenyl, naphthyl, acenaphthyl, anthraquinonyl, phenanthryl, anthracenyl, pyrenyl, perylenyl, and fluorenyl.

The term “aralkyl” refers to a monovalent group of formula —R—Ar where R is an alkylene and Ar is an aryl group. That is, the aralkyl is an alkyl substituted with an aryl.

The term “aralkylene” refers to a divalent group of formula —R—Ar^{a}— where R is an alkylene and Ar^{a} is an arylene (i.e., an alkylene is bonded to an arylene).

The term “arylene” refers to a divalent group that is carbocyclic and aromatic. The group has one to five rings that are connected, fused, or combinations thereof. The other rings can be aromatic, non-aromatic, or combinations thereof. In some embodiments, the arylene group has up to 5 rings, up to 4 rings, up to 3 rings, up to 2 rings, or one aromatic ring. For example, the arylene group can be phenylene. The term “alkarylene” refers to a divalent group that is an arylene group substituted with an alkyl group or an arylene group attached to an alkylene group. Unless otherwise indicated, the alkarylene group typically has from 1 to 20 carbon atoms, 4 to 14 carbon atoms, 1 to 10 carbon atoms, 1 to 6 carbon atoms, or 1 to 4 carbon atoms. Unless otherwise indicated, for both groups, the alkyl or alkylene portion typically has from 1 to 20 carbon atoms, 1 to 10 carbon atoms, 1 to 6 carbon atoms, or 1 to 4 carbon atoms. Unless otherwise indicated, for both groups, the aryl or arylene portion typically has from 6 to 20 carbon atoms, 6 to 18 carbon atoms, 6 to 16 carbon atoms, 6 to 12 carbon atoms, or 6 to 10 carbon atoms. In certain embodiments, the arylene group or the alkarylene group has 4 to 14 carbon atoms.

The term “aprotic” refers to a component that does not have a hydrogen atom bound to an oxygen (as in a hydroxyl group) or a nitrogen (as in an amine group). In general terms, any component that does not contain labile H⁺ is called an aprotic component. The molecules of such components cannot donate protons (Hz) to other components.

The term “carbamate” refers to a compound having the general formula R—N(H)—C(O)—O—R′. Preferred R groups include alkylene groups.

The term “diisocyanate” refers to a compound having the general formula O═C═N—R—N═C═O. Preferred R groups include alkylene and arylene groups.

The term “diol” refers to a compound with two OH groups.

The term “(meth)acrylate” means acrylate or methacrylate.

The term “triamine” refers to a compound with three amino groups.

The term “polyester” refers to repeating difunctional polymer wherein the repeat units are joined by ester linkages. Ester groups have the general formula —R—C(O)—OR′. The term “polyether” refers to repeating difunctional alkoxy radicals having the general formula —O—R—. Preferred R and R′ groups have the general formula —CₙH₂ₙ— and include, for example, methylene, ethylene and propylene (including n-propylene and i-propylene) or a combination thereof. Combinations of R and R′ groups may be provided, for example, as random or block type copolymers.

The term “polyol” refers to a compound with two or more hydroxyl (i.e., OH) groups.

The term “polymeric material” refers to any homopolymer, copolymer, terpolymer, and the like, as well as any diluent.

The term “primary alcohol” refers to an alcohol in which the OH group is connected to a primary carbon atom (e.g., having the general formula —CH₂OH). The term “secondary alcohol” refers to an alcohol in which the OH group is connected to a secondary carbon atom (e.g., having the general formula —CHROH, where R is a group containing a carbon atom).

The term “ambient temperature” refers to a temperature in the range of 20 degrees Celsius to 25 degrees Celsius, inclusive.

The terms “cure” and “curable” refer to joining polymer chains together by covalent chemical bonds, usually via crosslinking molecules or groups, to form a network polymer. Therefore, in this disclosure the terms “cured” and “crosslinked” may be used interchangeably. A cured or crosslinked polymer is generally characterized by insolubility, but may be swellable in the presence of an appropriate solvent.

The term “backbone” refers to the main continuous chain of a polymer.

The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the specific circumstance rather than requiring absolute precision or a perfect match.

### Extrudable Articles and Compositions

In a first aspect, an extrudable article is provided. The extrudable article comprises at least one polyurethane comprising hydroxyl groups and latent isocyanate groups in the form of uretdione groups, wherein the hydroxyl groups are present on a first polyurethane and the latent isocyanate groups are present on either the first polyurethane or a second polyurethane, wherein a ratio of the latent isocyanate groups to the hydroxyl groups is greater than 1.2:1.

In a second aspect, a composition is provided. The composition comprises at least one polyurethane comprising hydroxyl groups and latent isocyanate groups in the form of uretdione groups, wherein the hydroxyl groups are present on a first polyurethane and the latent isocyanate groups are present on either the first polyurethane or a second polyurethane, wherein a ratio of the latent isocyanate groups to the hydroxyl groups is greater than 1.2:1.

The first and second aspect are described in detail below.

It has been discovered that it is possible to provide the convenience of non-reactive polyurethanes (e.g., adhesives) as well as the high performance of reactive polyurethanes by employing a polyurethane (e.g., hotmelt adhesive) that contains latent isocyanate groups present as uretdione groups. Upon heating, uretdione groups revert to isocyanate groups and the resulting isocyanate-terminated polyurethane forms a material (e.g., adhesive) that can moisture cure to form covalent crosslinks in the polyurethane(s).

In existing powder coating applications and some other typical applications with uretdiones, a blocked isocyanate is used to cure/crosslink the material upon application of heat. In other words, the exposure to heat directly causes the sample to polymerize extensively and generally lose its ability to flow. To enable this behavior, these products are designed with a substantial stoichiometric balance between the isocyanates that become unblocked and the residual hydroxyl functionality in the formulation. In extrudable articles and compositions of the present disclosure, the same general chemical transformation is occurring (i.e., the reversion of the uretdione group back into two isocyanate groups); however, the application differs in the way it is designed and the way the isocyanates are then utilized. Specifically, according to the present disclosure there is a substantial stoichiometric excess of isocyanate (that becomes unblocked) relative to the residual hydroxyl functionality in the formulation, thus exposure to heat (e.g., during extrusion) does not directly cause the sample to cure. Rather, the excess of isocyanate end-caps the polymer chains, essentially changing the chain ends from hydroxyl groups to isocyanate groups with only a modest increase in molecular weight. This enables the polyurethane to remain flowable, so it can then be dispensed onto a substrate. Once dispensed, the sample will absorb ambient moisture, which will then react with the isocyanate end groups on the polyurethane to cause cure and crosslinking. Therefore, water absorption directly causes the cure, while the heat exposure only indirectly leads to curing.

As mentioned above, the hydroxyl groups are present on a first polyurethane and the latent isocyanate groups are present on either the first polyurethane or a second polyurethane. As such, in some cases, the article/composition comprises one polyurethane comprising both types of groups (i.e., hydroxyl groups and latent isocyanate groups). In some cases, the article/composition comprises two polyurethanes, each one comprising one of the types of groups (i.e., a first polyurethane comprises hydroxyl groups and a second polyurethane comprises latent isocyanate groups). Additionally, more than two polyurethanes could be included with any combination of one or both types of functional groups (i.e., hydroxyl groups and latent isocyanate groups) so long as the total amounts of the two types of groups are present in the recited ratio of the latent isocyanate groups to the hydroxyl groups being greater than 1.2:1.

Optionally, a suitable polyurethane comprises a reaction product of a polymerizable composition comprising:
a) a uretdione-containing material comprising a reaction product of a diisocyanate reacted with itself,
b) a hydroxyl-containing compound; and
c) an isocyanate-containing compound.

The ratio of the latent isocyanate groups to the hydroxyl groups being greater than 1.2:1 tends to assist in providing a polyurethane article or composition (e.g., hotmelt adhesive) that has a convenient solid form at ambient conditions, yet flowable when heated. A ratio of the latent isocyanate groups to the hydroxyl groups may be 1.25:1 or greater, 1.3:1 or greater, 1.4:1 or greater, 1.5:1 or greater, 1.6:1 or greater, 1.7:1 or greater, 1.8:1 or greater, or 1.9:1 or greater; and 3.0:1 or less, 2.9:1 or less, 2.8:1 or less, 2.7:1 or less, 2.6:1 or less, 2.5:1 or less, 2.4:1 or less, 2.3:1 or less, 2.2:1 or less, 2.1:1 or less, or 2.0:1 or less. With large excesses of latent isocyanate, the average molecular weight of the system can undesirably decrease in response to the heat-activation, and this could cause dispensing problems due to low viscosities and require more absorbed moisture to achieve similar levels of cure as compositions with smaller excesses of latent isocyanate.

The (at least one) polyurethane optionally has a latent isocyanate group content of 0.2 equivalents per kilogram or greater, 0.22, 0.24, 0.26, 0.28, 0.30, 0.32, 0.34, 0.36, 0.38, 0.40, 0.42, 0.44, or 0.45 equivalents per kilogram or greater; and 0.70 equivalents per kilogram or less, 0.68, 0.66, 0.64, 0.62, 0.60, 0.58, 0.56, 0.54, 0.52, 0.50, 0.48, or 0.48 equivalents per kilogram or less. Stated another way, the latent isocyanate group content of the polyurethane may be 0.20 to 0.70 equivalents per kilogram. Manufacturers typically specify the latent isocyanate content of uretdione-containing materials. Alternatively, the latent isocyanate content can be determined by using analytical techniques such and nuclear magnetic resonance (NMR) or infrared (IR) spectroscopy. The term “equivalent” means “moles” in this case, thus the isocyanate content in a material (in terms of equivalents/moles) is divided by the weight of the entire formulation to give a value of equivalents per kilograms.

The (at least one) polyurethane has a weight average molecular weight (Mw) that is usually 5,000 grams per mole (g/mol) or greater, such as 6,000 g/mol or greater, 7,000 g/mol, 8,000 g/mol, 9,000 g/mol, 10,000 g/mol, 12,000 g/mol, 15,000 g/mol, 17,000 g/mol, 20,000 g/mol, 22,000 g/mol, 25,000 g/mol, 27,000 g/mol, or 30,000 g/mol or greater; and 150,000 g/mol or less, 140,000 g/mol, 130,000 g/mol, 120,000 g/mol, 110,000 g/mol, 90,000 g/mol, 85,000 g/mol, 80,000 g/mol, 75,000 g/mol, 70,000 g/mol, 65,000 g/mol, 60,000 g/mol, 55,000 g/mol, 50,000 g/mol, 45,000 g/mol, 40,000 g/mol, 35,000 g/mol, 30,000 g/mol, or 25,000 g/mol or less. In certain cases, the polyurethane has a Mw of 10,000 g/mol to 50,000 g/mol.

Typically, the hydroxyl groups of the (at least one) polyurethane are present following reaction of a polymerizable composition comprising a uretdione-containing material, a hydroxyl-containing compound, and an isocyanate-containing compound. The polyurethane optionally has a hydroxyl group content of 0.15 equivalents per kilogram or greater, 0.16, 0.17, 0.18, 0.19, 0.20, 0.21, 0.22, 0.23, 0.24, or 0.25 equivalents per kilogram or greater; and 0.35 equivalents per kilogram or less, 0.34, 0.33, 0.32, 0.31, 0.30, 0.29, 0.28, 0.27, or 0.26 equivalents per kilogram or less.

A uretdione can be formed by the reaction of a diisocyanate with itself and has the following general formula:

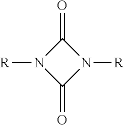

In some embodiments, the diisocyanate comprises a functional group selected from Formula X, Formula XI, and Formula XII:

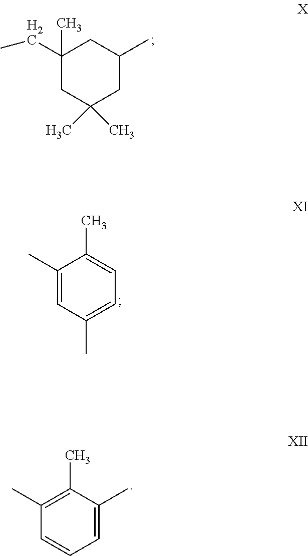

There are a variety of reaction products that can occur as a diisocyanate reacts with itself, and typically the reaction of a diisocyanate with itself results in a blend of two or more reaction products. Typically, the reaction of a diisocyanate with itself proceeds to a degree such that the resulting polymeric material contains 25% by weight or less or 23% by weight or less of isocyanate groups, as determined by infrared Fourier Transform spectroscopy (e.g., a Nicolet 6700 FT-IP Spectrometer, Thermo Scientific (Madison, WI)) where the weight percent of isocyanate in a material is calculated as the moles of isocyanate functional groups multiplied by 42 grams per mole (g/mol) and divided by the mass of the material.

In certain embodiments, the uretdione-containing material comprises a compound of Formula I.

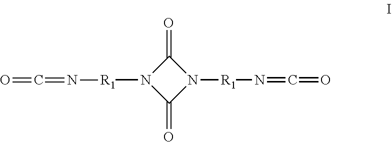

wherein R₁ is independently selected from a C₄ to C₁₄ alkylene, arylene, and alkarlyene. In some embodiments, the diisocyanate comprises hexamethylene diisocyanate. Often, at least one of the uretdione-containing material or the isocyanate-containing material comprises an aliphatic material and/or an aromatic material. One preferable uretdione-containing material is a hexamethylene diisocyanate-based blend of materials comprising uretdione functional groups, commercially available, for instance a material including hexamethylene diisocyanate (HDI), under the trade name DESMODUR N3400 from Covestro (Leverkusen, Germany). Additional uretdione-containing materials are commercially available, for instance a material including cycloaliphatic polyuretdione under the trade name CRELAN EF 403 also from Covestro, a material including 1,3-bis(3-isocyanato-4-methylphenyl)-1,3-diazetidin-2,4-dione under the trade name ISOQURE TT from Isochem Incorporated (New Albany, OH),

The hydroxyl-containing compound included in the polymerizable composition may comprise a single compound or more than one compound. In some cases, a suitable hydroxyl-containing compound has two or more hydroxyl groups (i.e., OH groups). For instance, 2.1 OH groups or greater, 2.2, 2.3, 2.4, 2.5, 2.6, 2.7, 2.8, 2.9, 3.0, 3.1, 3.2, 3.3, 3.4, or 3.5 OH groups or greater; and 6.0 OH groups or less, 5.9, 5.8, 5.7, 5.6, 5.5, 5.4, 5.3, 5.2, 5.1, 5.0, 4.9, 4.8, 4.7, 4.6, 4.5 4.4, 4.3, 4.2, 4.1, 4.0, 3.9, 3.8, 3.7, 3.6, 3.5, 3.4, 3.3, 3.2, 3.1, or 3.0 OH groups or less. In some cases, the hydroxyl-containing compound has greater than 2.0 OH groups to 6.0 OH groups. In certain embodiments, the hydroxyl-containing compound comprises a triol, an alkylene polyol, a polyester polyol, or a polyether polyol. In embodiments where the hydroxyl-containing compound has two or more hydroxyl groups, the polymerizable composition optionally further comprises a monofunctional alcohol. Including a monofunctional alcohol tends to slow the crosslinking of a polyurethane once the extrudable article or composition has been heated and dispensed on a substrate.

Often the hydroxyl-containing compound comprises a diol, such as a branched diol. For example, in some embodiments the hydroxyl-containing compound is of Formula II:

HO—R₂—OH II

wherein R₂ is selected from R₃, an alkylene, and an alkylene substituted with an OH group, wherein R₃ is of Formula III or Formula IV:

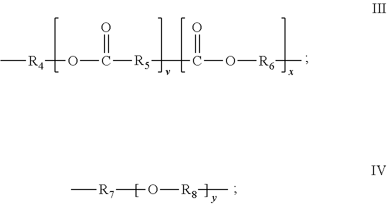

wherein each of R₄, R₅, R₆, R₇, and R₈ is independently an alkylene, wherein each of v and y is independently 1 to 40, and wherein x is selected from 0 to 40. Optionally, R₂ is selected from C₁ to C₂₀ alkylene and a C₁ to C₂₀ alkylene substituted with an OH group. In certain embodiments of the hydroxyl-containing compound, each of R₄, R₅, R₆, R₇, and R₈ is independently selected from a C₁ to C₂₀ alkylene.

Suitable hydroxyl-containing compounds include branched alcohols, secondary alcohols, or ethers, for instance and without limitation, 2,2-dimethyl-1,3-propanediol, 2-methyl-1,3-propanediol, diethylene glycol, poly(tetramethylene ether) glycol, poly(propylene glycol), 2-ethylhexane-1,3-diol, 1,4-butanediol, and 1,3-butanediol. At least some of these hydroxyl-containing compounds can act as a chain extender during polymerization, especially diols having 1 to 6 carbon atoms. Accordingly, in some embodiments, the hydroxyl-containing compound comprises a chain extender. Such suitable hydroxyl-containing compounds are commercially available from chemical suppliers including for example, Alfa Aesar (Ward Hill, MA), JT Baker (Center Valley, PA), TCI (Portland, OR), and Fisher Scientific (Waltham, MA). In select embodiments, the hydroxyl-containing compound comprises a polypropylene glycol polyol or a poly(tetramethylene ether) glycol.

The hydroxyl-containing compound can be of Formula V or Formula VI:

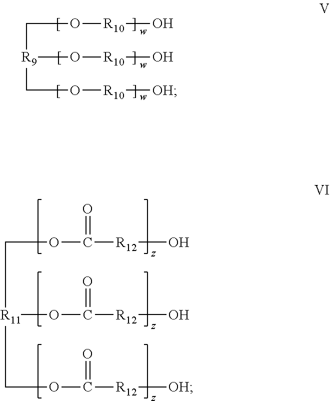

wherein each of R₉ and R₁₁ is independently an alkane-triyl, wherein each of R₁₀ and R₁₂ is independently selected from an alkylene, and wherein each of w and z is independently selected from 1 to 20. Preferably, each of R₁₀ and R₁₂ is independently selected from a C₁ to C₂₀ alkylene.

Preferably, the hydroxyl-containing compound has a number average molecular weight (Mn) of 1,000 to 6,000 g/mol, inclusive, 1,000 to 2,500 g/mol, inclusive, or 3,000 to 4,000 g/mol, inclusive. These Mn ranges of hydroxyl-containing compound tend to produce a good balance of viscosity, flexibility, and toughness. When using hydroxyl-containing compounds having a number average molecular weight that is too low, the carbamate groups of the resulting polymerized reaction product are more concentrated, leading to high viscosities, higher glass transition temperatures, and lower elongations. When using hydroxyl-containing compounds having a number average molecular weight that is too high, the carbamate groups of the resulting polymerized reaction product are too dilute and the toughness of a urethane is not achieved. In addition, with even higher weights, the polymerized reaction product molecular weight gets higher and the viscosity gets high.

In certain embodiments, the hydroxyl-containing compound comprises an alkyl alcohol, a polyester alcohol, or a polyether alcohol, such as a branched alcohol and/or a secondary alcohol. For example, in some embodiments the hydroxyl-containing compound is of Formula VII:

R₁₃—OH VII;

wherein R₁₃ is selected from R₁₄, R₁₅, and a C₁ to C₅₀ alkyl;

wherein R₁₄ is of Formula VIII:

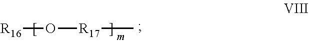

wherein m=1 to 20, R₁₆ is an alkyl, and R₁₇ is an alkylene;

wherein R₁₅ is of Formula IX:

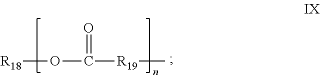

wherein n=1 to 20, R₁₈ is an alkyl, and R₁₉ is an alkylene. Preferably, R₁₃ is a C₄-C₂₀ alkyl, as the alkyl groups below C₄ have a tendency to form a crystalline polymeric material.

Suitable hydroxyl-containing compounds can include branched alcohols or secondary alcohols, for instance and without limitation, 2-butanol, 2-ethyl-1-hexanol, isobutanol, and 2-butyl-octanol, each of which is commercially available from Alfa Aesar (Ward Hill, MA). As such, in some embodiments, the hydroxyl-containing compound has only one OH group.

Suitable polyester polyols have more than one hydroxyl group and preferably at least two terminal hydroxyl groups. In some preferred cases, the polyester polyol comprises at least one of an adipate (e.g., butylene adipate, hexamethylene adipate, or ethylene adipate) or a polycaprolactone. Long polyester chains tend to crystallize during polymerization. Poly(hexamethylene adipate) and poly(butylene adipate) tend to form polyurethanes with significant crystallization in the soft segment domains.

In certain cases, the isocyanate-containing compound is provided as a side product in the uretdione-containing material and thus would not require separate addition of the isocyanate-containing compound to the polymerizable composition. In some cases, an isocyanate-containing compound is individually added, such as a compound having two or more isocyanate groups (e.g., polyisocyanates). Examples of suitable isocyanate-containing compounds include for instance and without limitation, 2-isocyanatoethyl methacrylate (IEM), m-isopropenyl-α,α-dimethylbenzyl isocyanate (m-TMI) and methacryloyl isocyanate. Polyisocyanates include diisocyanates, triisocyanates, and higher functional isocyanates, including polymeric isocyanates. They may be aliphatic (including alicyclic) and cyclic (including aromatic). Examples of diisocyanates include 4,4′-methylenediphenylenediisocyanate (MDI), 2,4-toluenediisocyanate, 2,6-toluene diisocyanate, o, m, and p-xylylene diisocyanate, 4,4′-diisocyanatodiphenylether, 3,3′-dichloro-4,4′-diisocyanatodiphenylmethane, 4,4′-diphenyldiisocyanate, 4,4′-diisocyanatodibenzyl, 3,3′-dimethoxy-4,4′-diisocyanatodiphenyl, 3,3′-dimethyl-4,4′-diisocyanatodiphenyl, 2,2′-dichloro-5,5′-dimethoxy-4,4′-diisocyanato diphenyl, 1,3-diisocyanatobenzene, 1,2-naphthylene diisocyanate, 4-chloro-1,2-naphthylene diisocyanate, 1,3-naphthylene diisocyanate, and 1,8-dinitro-2,7-naphthylene diisocyanate; alicyclic diisocyanates such as 3-isocyanatomethyl-3,5,5-trimethylcyclohexylisocyanate; 3-isocyanatomethyl-3,5,5-trimethylcyclohexylisocyanate; aliphatic diisocyanates such as 1,6-hexamethylenediisocyanate, 2,2,4-trimethyl-1,6-hexamethylenediisocyanate, and 1,2-ethylenediisocyanate; cyclic diisocyanates such as isophorone diisocyanate (IPDI) and dicyclohexylmethane-4,4′-diisocyanate. Examples of triisocyanates include aliphatic triisocyanates such as 1,3,6-hexamethylenetriisocyanate and aromatic triisocyanates such as tri-(4-isocyanatophenyl)-methane. An example of a polymeric isocyanate includes polymethylenepolyphenylisocyanate (PAPI). An example of an aliphatic polyisocyanate is available under the tradename Desmodur N 100 from Bayer MaterialScience LLC, Pittsburgh, PA, which is based on hexamethylene diisocyanate (HDI). In some cases, suitable isocyanate containing compounds include prepolymers formed as the reaction product of diols with an excess of diisocyanate monomers.

Regarding any of the polyurethanes described above, the polymerized reaction product is optionally present in an amount of 50% by weight or greater, based on the total weight of the extrudable article or composition, 55% by weight or greater, 60% by weight, 65% by weight, 70% by weight, 75% by weight, or 80% by weight or greater, based on the total weight of the extrudable article or composition; and 100% by weight or less, 98% by weight, 96% by weight, 95% by weight, 90% by weight, 85% by weight, or 80% by weight or less, based on the total weight of the extrudable article or composition.

The extrudable article or composition may further comprise one or more additives, e.g., catalysts, plasticizers, non-reactive diluents, toughening agents, fillers, flow control agents, colorants (e.g., pigments and dyes), adhesion promoters, UV stabilizers, flexibilizers, fire retardants, antistatic materials, thermally and/or electrically conductive particles, and expanding agents including, for example, chemical blowing agents such as azodicarbonamide or expandable polymeric microspheres containing a hydrocarbon liquid, such as those sold under the tradename EXPANCEL by Expancel Inc. (Duluth, GA).

Catalysts may be present in polymerizable compositions according to the present disclosure. For example, suitable catalysts can include amines or organometallic catalysts such as tin compounds, bismuth compounds, zinc compounds, and zirconium compounds. Optionally, a bismuth carboxylate may be a suitable catalyst, for instance bismuth neodecanoate and/or bismuth ethylhexanoate. Typically, such catalysts can be included to accelerate reaction of the uretdione-containing material with one or more hydroxyl-containing compounds. In select embodiments, the components are free of catalysts that contain tin. Suitable amine catalysts include cyclohexyldimethylamine, 2-dimethylaminoethanol, 4-ethylmorpholine, N,N,4-trimethylpiperazine-1-ethylamine, 1,4-dimethylpiperazine, 3-aminopropyldimethylamine, 2,2′-iminodiethanol, 1-methylimidazole, 1,2-dimethylimidazole, 2-[[2-(dimethylamino)ethyl]methylamino]ethanol, N-[3-(dimethylamino)propyl]-N,N′,N′-trimethylpropane-1,3-diamine, formic acid, compound with 2,2′-oxybis[N,N-dimethylethylamine](2:1), 1,1′-[[3-(dimethylamino)propyl]imino]bispropan-2-ol, 2-[(2-[2-(dimethylamino)ethoxy]ethyl)methylamino]ethanol, benzyldimethylamine 4-methylmorpholine, N,N,N′,N′-tetramethylhexamethylenediamine, 2-[2-(dimethylamino)ethoxy]ethanol, 1,4-diazabicyclooctane, bis(2-dimethylaminoethyl)(methyl)amine, N,N,N′,N′-tetramethyl-2,2′-oxybis(ethylamine, 2,2′-dimorpholinyldiethyl ether, 1,8-diazabicyclo[5.4.0]undec-7-ene, N′-[3-(dimethylamino)propyl]-N,N-dimethylpropane-1,3-diamine, N,N,N′,N′,N″,N″-hexamethyl-1,3,5-triazine-1,3,5(2H,4H,6H)-tripropanamine, N,N-bis[3-(dimethylamino)propyl]-N′,N′-dimethylpropane-1,3-diamine.

In addition to the above discussed additives, further additives can be included in the extrudable article or composition. For example, any or all of antioxidants/stabilizers, colorants, abrasive granules, thermal degradation stabilizers, light stabilizers, conductive particles, tackifiers, flow agents, bodying agents, flatting agents, inert fillers, binders, blowing agents, fungicides, bactericides, surfactants, plasticizers, thixotropic agents, and other additives known to those skilled in the art. Suitable thixotropic agents include for instance, ultra-fine silica powder, surfactants, antifoamers, colorants, electrically conductive particles, antistatic agents, and metal deactivators. These additives, if present, are added in an amount effective for their intended purpose. The amount and type of such additives may be selected by one skilled in the art, depending on the intended end use of the composition.

The form of the extrudable article is not particularly limited, and may include a form of a filament, a ribbon, a plurality of pellets, or a pumpable melt. In some cases, a form of a filament is preferred. A filament comprises at least the (at least one) polyurethane, and optionally additional materials. One type of filament is a core-sheath filament.

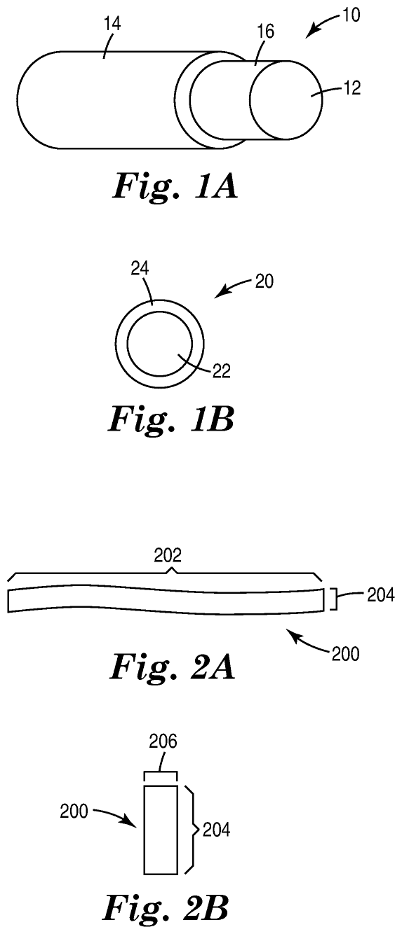

An example core-sheath filament 10 is shown schematically in FIG. 1A. The filament includes a core 12 and a sheath 14 surrounding (encasing) the outer surface 16 of the core 12. FIG. 1B shows the core-sheath filament 20 in a cross-sectional view. The core 22 is surrounded by the sheath 24. Any desired cross-sectional shape can be used for the core. For example, the cross-sectional shape can be a circle, oval, square, rectangular, triangular, or the like. The cross-sectional area of the core 22 is typically larger than the cross-sectional area of the sheath 24. In addition to shape and area, the cross-section of the filament also includes cross-sectional distances. Cross-sectional distances are equivalent to the lengths of chords that could join points on the perimeter of the cross-section. The term “longest cross-sectional distance” refers to the greatest length of a chord that can be drawn through the cross-section of a filament, at a given location along its axis.

The core-sheath filament usually has a relatively small longest cross-sectional distance (e.g., the longest cross-sectional distance corresponds to the diameter for filaments that have a circular cross-sectional shape) so that it can be used in applications where precise deposition of a composition is needed or is advantageous. For instance, the core-sheath filament usually has a longest cross-sectional distance in a range of 1 to 20 millimeters (mm). The longest cross-sectional distance of the filament can be at least 1 mm, at least 2 mm, at least 3 mm, at least 4 mm, at least 5 mm, at least 6 mm, at least 8 mm, or at least 10 mm and can be up to 20 mm, up to 18 mm, up to 15 mm, up to 12 mm, up to 10 mm, up to 8 mm, up to 6 mm, or up to 5 mm. This average distance can be, for example, in a range of 2 to 20 mm, 5 to 15 mm, or 8 to 12 mm.

Often, 1 to 25 percent of the longest cross-sectional distance (e.g., diameter) of the core-sheath filament is contributed by the sheath and 75 to 99 percent of the longest cross-sectional distance (e.g., diameter) of the core-sheath filament is contributed by the core. For example, up to 25 percent, up to 23 percent, up to 21 percent, up to 20 percent, up to 18 percent, up to 17 percent, up to 15 percent, up to 13 percent, up to 11 percent, up to 10 percent, up to 9 percent, up to 8 percent, up to 7 percent, up to 6 percent, up to 5 percent, up to 4 percent, up to 3 percent, or up to 2 percent and at least 1 percent, at least 2 percent, at least 4 percent, at least 5 percent, at least 6 percent, at least 8 percent, at least 10 percent, or at least 12 percent of the longest cross-sectional distance of the filament can be contributed by the sheath with the remainder being contributed by the core. The sheath extends completely around the perimeter (e.g., circumference, in the case of a circular cross-section) of the core to prevent the core from sticking to itself. In some embodiments, however, the ends of the filament may contain only the core.

Often, the core-sheath filament has an aspect ratio of length to longest cross-sectional distance (e.g., diameter) of 50:1 or greater, 100:1 or greater, or 250:1 or greater. Core-sheath filaments having a length of at least about 20 feet (6 meters) can be especially useful for printing a composition. Depending on the application or use of the core-sheath filament, having a relatively consistent longest cross-sectional distance (e.g., diameter) over its length can be desirable. For instance, an operator might calculate the amount of material being melted and dispensed based on the expected mass of filament per predetermined length; but if the mass per length varies widely, the amount of material dispensed may not match the calculated amount. In some embodiments, the core-sheath filament has a maximum variation of longest cross-sectional distance (e.g., diameter) of 20 percent over a length of 50 centimeters (cm), or even a maximum variation in longest cross-sectional distance (e.g., diameter) of 15 percent over a length of 50 cm.

Core-sheath filaments described herein can exhibit a variety of desirable properties. As formed, a core-sheath filament desirably has strength consistent with being handled without fracturing or tearing of the sheath. The structural integrity needed for the core-sheath filament varies according to the specific application of use. Preferably, a core-sheath filament has strength consistent with the requirements and parameters of one or more additive manufacturing devices (e.g., 3D printing systems). One additive manufacturing apparatus, however, could subject the core-sheath filament to a greater force when feeding the filament to a deposition nozzle than a different apparatus. As formed, the core-sheath filament desirably also has modulus and yield stress consistent with being handled without excessive or unintentional stretching.

When the extrudable article is in a core-sheath filament form, the core comprises the (at least one) polyurethane, the sheath comprises an ethylene copolymer or a polyolefin, and the sheath surrounds the core.

The sheath can provide advantages of excluding moisture from the polyurethane core, especially during the manufacturing of the core-sheath filament when the filament may be passed through a water bath. In such cases, sheath materials with water barrier properties are desirable.

In some embodiments, the sheath material may be a polyolefinic material, meaning that the sheath material is made up of at least 80 wt. % polyalkene polymers, including any homopolymers, copolymers, blends, etc. thereof. Optionally, the sheath material may comprise at least 90 wt. %, at least 95 wt. %, or at least 98 wt. %, polyolefinic material. In some cases, the sheath material consists essentially of polyolefinic material, noting that this requirement does not preclude the presence of processing aids, plasticizers, antioxidants, colorants, pigments, and the like, at least some of which may contain some small level of non-polyolefinic material.

Sheath materials with good water barrier properties include polyolefins such as polyethylene, low density polyethylene, linear low density polyethylene, high density polyethylene, ethylene propylene diene monomer rubber (EPDM), polypropylene, polyisobutylene, butyl rubber, and polyolefinic copolymers. In some cases, low density polyethylene is a suitable sheath material having good water barrier properties.

Ethylene copolymers, such as ethylene vinyl acetate and ethylene acrylic ester copolymers can also be suitable. Preferred copolymers for barrier properties can contain a high fraction of ethylene. In some cases, ethylene vinyl acetate copolymer has a vinyl acetate content less than 25% or less than 20% or less than 15% or less than 10%. In some cases, ethylene vinyl acetate copolymer has a vinyl acetate content of more than 2% or more than 5% or more than 10%.

Suitable ethylene vinyl acetate (“EVA”) polymers (i.e., copolymers of ethylene with vinyl acetate) for use in the sheath include resins from Dow, Inc. (Midland, MI) available under the trade designation ELVAX. Typical grades range in vinyl acetate content from 9 to 40 weight percent and a melt flow index of as low as 0.3 grams/10 minutes (per ASTM D1238-13). One exemplary material is ELVAX 3135 SB with a MFI of 0.4 grams/10 minutes. Suitable EVAs also include high vinyl acetate ethylene copolymers from LyondellBasell (Houston, TX) available under the trade designation ULTRATHENE. Typical grades range in vinyl acetate content from 12 to 18 weight percent. Suitable EVAs also include EVA copolymers from Celanese Corporation (Dallas, TX) available under the trade designation ATEVA. Typical grades range in vinyl acetate content from 2 to 26 weight percent.

Preferred sheath materials can be readily extruded at temperatures lower than temperatures that cause the isocyanate groups become unblocked. Low density polyethylene (LDPE) and EVA copolymer can be suitable for extrusion at advantageously low temperatures.

To provide the desirable water barrier properties, the sheath content relative to the total weight of the core-sheath filament can be greater than 4 weight percent or greater than 6 weight percent or greater than 8 weight percent or greater than 10 weight percent. The sheath content can be less than 25 weight percent or less than 20 weight percent, or less than 15 weight percent, or less than 10 weight percent.

Optionally, the sheath further comprises an antiblock material. An antiblock material can either be applied to an exterior surface of the sheath (e.g., included in a solvent such as water and coated onto the sheath), directly incorporated into the sheath material, or included in a cooling bath through which the core-sheath filament is passed. When the antiblock material is included in the sheath material, the antiblock material blooms out to the exterior surface of the sheath over time. Exemplary antiblock agents are typically inorganic materials such as diatomaceous earth, talc, calcium carbonate, clay, mica and ceramic spheres and organic materials such as waxes and polyalkylene glycol polymers. Exemplary antiblock agents are available, for example, under the trade designations ABC5000 from Polyfil Corporation, Rockaway, NJ; AMPACET 102077 from Ampacet, Tarrytown, NY; and MASTERWAX from Deurex AG, Elsteraue, Germany.

The sheath typically makes up 1 to 15 weight percent of the total weight of the core-sheath filament. The amount of the sheath is selected to provide a sufficiently robust core-sheath filament that can be easily handled without rupture or tearing of the sheath on the filament. The amount of the sheath material used in the core-sheath filament is often selected to be as low as possible because the sheath composition typically does not enhance (and can often diminish) the performance of the polyurethane composition within the core. The amount of the sheath in the core-sheath filament can be at least 1 weight percent, at least 2 weight percent, at least 3 weight percent, at least 4 weight percent, at least 5 weight percent, at least 6 weight percent, at least 8 weight percent, at least 10 weight percent, at least 12 weight percent, at least 14 weight percent; and up to 25 weight percent, up to 20 weight percent, up to 15 weight percent, up to 13 weight percent, up to 11 weight percent, up to 10 weight percent, up to 9 weight percent, up to 8 weight percent, up to 7 weight percent, up to 6 weight percent, or up to 5 weight percent based on the total weight of the core-sheath filament.

Advantageously, the elongation at break of the sheath material of the core-sheath filament is typically 50 percent or greater, 60 percent or greater, 80 percent or greater, 100 percent or greater, 250 percent or greater, 400 percent or greater, 750 percent or greater, 1000 percent or greater, 1400 percent or greater, or 1750 percent or greater and 2000 percent or less, 1500 percent or less, 900 percent or less, 500 percent or less, or 200 percent or less. Stated another way, the elongation at break of the sheath material of the core-sheath filament can range from 50 percent to 2000 percent. In some embodiments, the elongation at break is at least 60 percent, at least 80 percent, or at least 100 percent. Elongation at break can be measured, for example, by the methods outlined in ASTM D638-14, using test specimen Type IV.

Advantages provided by at least certain embodiments of employing the core-sheath filament as an adhesive once it is melted and mixed include one or more of: low volatile organic compound (“VOC”) characteristics, avoiding die cutting, design flexibility, achieving intricate non-planar bonding patterns, printing on thin and/or delicate substrates, eliminating liners and carriers, and printing on an irregular and/or complex topography.

Referring to FIGS. 2A and 2B, in some embodiments the extrudable article is in a form of a ribbon 200. As defined, a ribbon has an aspect ratio of length 202 to longest cross-sectional distance (e.g., diameter) 204 of 20:1 or greater and has a ratio of longest cross-sectional distance 204 to shortest cross-sectional distance (e.g., thickness) 206 of 2:1 or greater. This ratio of 2:1 or greater of longest cross-sectional distance 204 to shortest cross-sectional distance 206 is in contrast to a filament form, which has a ratio longest cross-sectional distance to shortest cross-sectional distance that is less than 2:1. This ribbon lacks a sheath. In other embodiments, the ribbon can have a sheath. For instance, the ribbon can be formed as a sheet, then a stack of the sheets can be formed having a thickness suitable for the ribbon. Next, a sheath composition can be positioned around the stack such that the sheath composition surrounds the stack. The surrounded stack can then be slit into individual ribbon core-sheath filaments, e.g., generally lacking sheath material along the slit edges of the ribbon. A ribbon typically has the same ranges as described above for core-sheath filaments with respect to each of longest cross-sectional distance, aspect ratio of length to longest cross-sectional distance, and maximum variation of longest cross-sectional distance over a length of 50 cm.

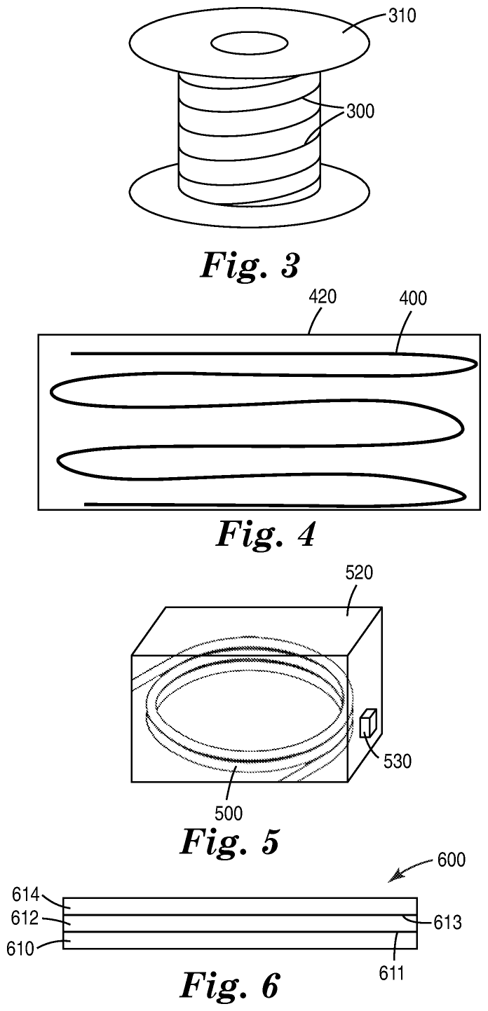

Referring to FIG. 3, in some cases the extrudable article is in a form of a filament 300 and the filament 300 or a ribbon (not shown) is wound on a spool 310. In general, a spool can be a convenient way to store a filament or a ribbon from which the filament or ribbon may be unwound as it is fed to an extruder during use. Similarly, referring to FIG. 4, in some cases the extrudable article is in a form of a filament 400 or a ribbon (not shown) and is provided as a festoon. A festoon is a looped configuration of the filament 400 or ribbon such that portions of a continuous length fold (e.g., loop) back over adjacent portions. The festoon is typically placed in a container 420 like a box sized to accommodate the loop lengths. In general, a festoon can be a convenient configuration for a filament or a ribbon from which the filament or ribbon is fed to an extruder during use.

Suitable filaments and ribbons should have at least a certain minimum tensile strength so that large spools or festoons of filament or ribbon can be continuously fed to a nozzle without breaking. Filaments and ribbons are often spooled into level wound rolls. If a core-sheath filament is spooled into level wound rolls, for instance, the material nearest the core can be subjected to high compressive forces. Preferably, the filament (e.g., core-sheath filament) or ribbon is resistant to permanent cross-sectional deformation (i.e., compression set) and self-adhesion (i.e., blocking during storage).

It has been discovered that it is possible for the extrudable article or composition to absorb moisture from the environment. Depending on storage conditions, in some cases the extrudable article or composition is hermetically sealed in a package. Further, a desiccant is optionally present in the package or as a component of the package to further minimize absorption of moisture by the extrudable article or composition during storage. Referring to FIG. 5, a schematic perspective view is provided of an exemplary extrudable article 500 having a shape of a filament and wrapped in a coil. The extrudable article 500 is hermetically sealed in a package 520 and in this embodiment a separate desiccant 530 is also included inside the sealed package 520. In alternate embodiments, a desiccant could be incorporated into the structure of the package, e.g., disposed within a polymeric film or wall that forms the package. The form of the package is not particularly limited and for instance can be a pouch, a bag, a box, etc.

### Method of Making a Core-Sheath Filament

In a third aspect, a method of making a core-sheath filament is provided. The method comprises:
forming a core composition comprising at least one polyurethane comprising hydroxyl groups and latent isocyanate groups in the form of uretdione groups, wherein the hydroxyl groups are present on a first polyurethane and the latent isocyanate groups are present on either the first polyurethane or a second polyurethane, wherein a ratio of the latent isocyanate groups to the hydroxyl groups is greater than 1.2:1;
forming a sheath composition comprising an ethylene copolymer or a polyolefin; and
wrapping the sheath composition around the core composition to provide the core-sheath filament.

In many embodiments, the method of making the core-sheath filament includes co-extruding the core composition and the sheath composition (e.g., though a coaxial die) such that the sheath composition surrounds the core composition. Optional additives for the core composition can be added in an extruder (e.g., a twin-screw extruder) equipped with a side stuffer that allows for the inclusion of additives. Similarly, optional additives can be added to a sheath composition in the extruder. The polyurethane core can be extruded through the center portion of a coaxial die having an appropriate diameter while the non-tacky sheath can be extruded through the outer portion of the coaxial die. One suitable die is a filament spinning die as described in U.S. Pat. No. 7,773,834 (Ouderkirk et al.). Optionally, the filament can be cooled upon extrusion using a water bath. The filament can be lengthened using a belt puller and the speed of the belt puller can be adjusted to achieve a desired filament diameter.

In other embodiments, the core can be formed by extrusion of the core composition. The resulting core can be rolled within a sheath composition having a size sufficient to surround the core. In still other embodiments, the core composition can be formed as a sheet. A stack of the sheets can be formed having a thickness suitable for the filament. A sheath composition can be positioned around the stack such that the sheath composition surrounds the stack.

The (at least one) polyurethane and the core-sheath filament are as described in detail above with respect to the first and second aspects.

### Method of Making an Extrudable Article

In a fourth aspect, a method of making an extrudable article is provided. The method comprises:
reacting in an extruder a polymerizable composition comprising:
i) a uretdione-containing material comprising a reaction product of a diisocyanate reacted with itself,
ii) a hydroxyl-containing compound; and
iii) an isocyanate-containing compound,
wherein the extrudable article comprises at least one polyurethane comprising hydroxyl groups and latent isocyanate groups in the form of uretdione groups, wherein the hydroxyl groups are present on a first polyurethane and the latent isocyanate groups are present on either the first polyurethane or a second polyurethane, wherein a ratio of the latent isocyanate groups to the hydroxyl groups is greater than 1.2:1.

The polymerizable composition is as described above in detail in with respect to the first and second aspects. Suitable extruders are as described in detail below with respect to the fifth aspect.

Typically, the extrudable article has a form of a filament, a ribbon, a plurality of pellets, or a pumpable melt. In some cases, the extrudable preferably has a form of a filament.

### Methods of Printing a Composition

In a fifth aspect, a method of printing a composition is provided. The method comprises:
a) feeding an extrudable article to an extruder, the extrudable article comprising at least one polyurethane comprising hydroxyl groups and latent isocyanate groups in the form of uretdione groups, wherein the hydroxyl groups are present on a first polyurethane and the latent isocyanate groups are present on either the first polyurethane or a second polyurethane, wherein a ratio of the isocyanate groups to the hydroxyl groups is greater than 1.2:1;
b) heating and mixing the extrudable article in the extruder to form a molten composition; and
c) dispensing the molten composition through a nozzle of the extruder onto a substrate.

The composition is not particularly limited, and may be, e.g., a sealant, an adhesive, etc. The curable compositions may be useful for coatings, shaped articles, adhesives (including structural and semi-structural adhesives), magnetic media, caulking and sealing compounds, impregnating and coating compounds, protective coatings for electronics, as primers or adhesion-promoting layers, and other applications that are known to those skilled in the art. Often the composition is dispensed in a predetermined pattern on the substrate, which is an advantage of using a nozzle for fine control of a desired deposition pattern.

Typically, the extrudable article has a form of a filament, a ribbon, a plurality of pellets, or a pumpable melt, e.g., a core-sheath filament made according to the third aspect above.

It is not necessary for the extrudable article to have a large aspect ratio (e.g., as in a filament or ribbon) for use in extrusion. Alternatively, the extrudable article has the form of a plurality of pellets or a pumpable melt and is fed to the extruder using a drum unloader or a pail unloader, as known to those of skill in the art. In certain cases, it is advantageous to dry the extrudable article shortly prior to feeding to the extruder to minimize the possibility of moisture being present to react in the extruder and form undesirable gas bubbles.

The molten composition usually exhibits a complex viscosity of 50 pascal·seconds (Pa·s) or greater, for instance as determined using oscillatory shear at 1.0 rad/s and 1.0% strain at a temperature of 210° C. The molten composition may exhibit a complex viscosity of 75 Pa·s or greater, 90 Pa·s, 100 Pa·s, 125 Pa·s, 150 Pa·s, 175 Pa·s, 200 Pa·s, 225 Pa·s, 250 Pa·s, 275 Pa·s, 300 Pa·s, 350 Pa·s, 400 Pa·s, 450 Pa·s, 500 Pa·s, 550 Pa·s, 600 Pa·s, 650 Pa·s, 700 Pa·s, 750 Pa·s, 800 Pa·s, 850 Pa·s, 900 Pa·s, 950 Pa·s, 1,000 Pa·s, 1,100 Pa·s, 1,200 Pa·s, 1,300 Pa·s, 1,400 Pa·s, 1,500 Pa·s, 1,600 Pa·s, 1,700 Pa·s, 1,800 Pa·s, 1,900 Pa·s, or 2,000 Pa·s or greater; and 15,000 Pa·s or less, 14,500 Pa·s, 14,000 Pa·s, 13,500 Pa·s, 13,000 Pa·s, 12,500 Pa·s, 12,000 Pa·s, 11,500 Pa·s, 11,000 Pa·s, 10,500 Pa·s, 10,000 Pa·s, 9,500 Pa·s, 9,000 Pa·s, 8,500 Pa·s, 8,000 Pa·s, 7,500 Pa·s, 7,000 Pa·s, 6,500 Pa·s, 6,000 Pa·s, 5,500 Pa·s, 5,000 Pa·s, 4,500 Pa·s, 4,000 Pa·s, 3,500 Pa·s, 3,000 Pa·s, or 2,500 Pa·s or less. Further details regarding testing the viscosity are described in the Examples below. Complex viscosities within the above ranges tend to be a result of several factors, including at least temperature of the molten composition, polyurethane molecular weight (e.g., a polyurethane having a Mw of 5,000 g/mol to 150,000 g/mol as described above), and isocyanate functionality of the at least one polyurethane.

The molten composition can be formed before reaching the nozzle, can be formed by mixing in the nozzle, or can be formed during dispensing through the nozzle, or a combination thereof. Preferably, when a core-sheath filament is employed, the sheath composition is uniformly blended throughout the core composition.

Fused Filament Fabrication, which is also known under the trade designation “FUSED DEPOSITION MODELING” from Stratasys, Inc., Eden Prairie, Minn., is a process that uses a thermoplastic strand fed through a hot can to produce a molten aliquot of material from an extrusion head. The extrusion head extrudes a bead of material in 3D space as called for by a plan or drawing (e.g., a computer aided drawing (CAD file)). The extrusion head typically lays down material in layers, and after the material is deposited, it fuses.

One suitable method for printing a filament onto a substrate is a continuous non-pumped filament-fed dispensing unit. In such a method, the dispensing throughput is regulated by a linear feed rate of the filament allowed into the dispense head. In most currently commercially available FFF dispensing heads, an unheated filament is mechanically pushed into a heated zone, which provides sufficient force to push the filament out of a nozzle. A variation of this approach is to incorporate a conveying screw in the heated zone, which acts to pull in a filament from a spool and to create pressure to dispense the material through a nozzle. Although addition of the conveying screw into the dispense head adds cost and complexity, it does allow for increased throughput, as well as the opportunity for a desired level of component mixing and/or blending. A characteristic of filament-fed dispensing is that it is a true continuous method, with only a short segment of filament in the dispense head at any given point. There can be several benefits to filament-fed dispensing methods compared to traditional hot melt adhesive deposition methods. First, filament-fed dispensing methods typically permits quicker changeover to different materials (e.g., adhesives). Also, these methods do not use a semi-batch mode with melting tanks, and this minimizes the opportunity for thermal degradation of a material and associated defects in the deposited composition. Filament-fed dispensing methods can use materials with higher melt viscosity, which affords a bead that can be deposited with greater geometric precision and stability without requiring a separate curing or crosslinking step. In addition, higher molecular weight raw materials can be used because of the higher allowable melt viscosity. This is advantageous because uncured hot melt adhesives containing higher molecular weight raw materials can have significantly improved high temperature holding power while maintaining stress dissipation capabilities.

Extrusion-based layered deposition systems (e.g., fused filament fabrication systems) are useful for making articles including printed compositions in methods of the present disclosure. Deposition systems having various extrusion types of are commercially available, including single screw extruders, twin screw extruders, hot-end extruders (e.g., for filament feed systems), and direct drive hot-end extruders (e.g., for elastomeric filament feed systems). Often, each of the extruder and the nozzle of the extruder is operated at a temperature of greater than 300° F. (148.9° C.), such as 325° F. (162.8° C.) or greater, 350° C. (176.7° C.), 375° F. (190.6° C.), 380° F. (193.3° C.), 385° F. (196.1° C.), 390° F. (198.9° C.), 395° F. (201.7° C.), or 400° F. (204.4° C.) or greater; and 485° F. (251.7° C.) or less. The extruder and the nozzle of the extruder can be operated at temperatures that are different from each other. Temperatures this high can be employed because the (at least one) polyurethane is only subjected to the heat for about 0.5 to 3 minutes within the extruder, so undesirable side reactions rarely occur due to exposure to the high temperatures. Upon cooling after leaving the extruder, molecular entanglement of the polyurethane(s) can provide fast adhesive strength. Then subsequent crystallization of molten composition occurs over hours, which can further increase adhesive strength. Additionally, the heating reverts the uretdione groups of the (at least one) polyurethane back to isocyanate groups, providing relatively low molecular weight polyurethane(s). After application to the substrate, ambient moisture reacts with the isocyanate end groups, which leads to crosslinking of the adhesive, building of molecular weight, and relatively high thermal stability.

Deposition systems can also have different motion types for the dispensing/deposition of a material, including using XYZ stages, gantry cranes, and robot arms. Common manufacturers of additive manufacturing deposition systems include Stratasys, Ultimaker, MakerBot, Airwolf, WASP, MarkForged, Prusa, Lulzbot, BigRep, Cosin Additive, and Cincinnati Incorporated. Suitable commercially available deposition systems include for instance and without limitation, BAAM, with a pellet fed screw extruder and a gantry style motion type, available from Cincinnati Incorporated (Harrison, OH); BETABRAM Model P1, with a pressurized paste extruder and a gantry style motion type, available from Interelab d.o.o. (Senovo, Slovenia); AM1, with either a pellet fed screw extruder or a gear driven filament extruder as well as a XYZ stages motion type, available from Cosine Additive Inc. (Houston, TX); KUKA robots, with robot arm motion type, available from KUKA (Sterling Heights, MI); and AXIOM, with a gear driven filament extruder and XYZ stages motion type, available from AirWolf 3D (Fountain Valley, CA).

One approach to form a covalently-crosslinked polyurethane that has better heat resistance than a linear polymer system is to use a high functionality of isocyanate groups (e.g., a polyurethane having an average of greater than 2.0 functional groups per molecule), such as by including a branched polyurethane in the molten composition that is dispensed from the extruder, followed by moisture curing.

In some embodiments, the composition may function as a structural adhesive, i.e., the curable composition is capable of bonding a first substrate to a second substrate, after curing. Generally, the bond strength (e.g., peel strength, overlap shear strength, or impact strength) of a structural adhesive continues to build well after the initial cure time. In certain embodiments, the composition is an adhesive that exhibits a minimum overlap shear strength on aluminum of 1.0 megaPascals (MPa) at least a week after dispensing, such as a minimum overlap shear strength on aluminum of 2 MPa, 3 MPa, 4 MPa, 5 MPa, 6 MPa, 7 MPa, 8 MPa, 9 MPa, 10 MPa, 12 MPa, 15 MPa, 17 MPa, or 20 MPa. A suitable test for determining the minimum overlap shear strength is described in the Examples below.

In cases where the composition is an adhesive, the substrate on which the composition is deposited optionally comprises a release liner. Other suitable substrates include for instance a metal (e.g., steel), a glass, a wood, a ceramic, or a polymeric material. The composition may also be employed with one or more substrates that have moisture permeability, for instance but without limitation, woven materials, nonwoven materials, paper, foams, membranes, and polymeric films. The dispensed composition typically coats at least a portion of a substrate, and up to the entire surface of a substrate depending on the application. Optionally, the printed adhesive forms a discontinuous pattern on the substrate.

Any method of printing a composition may further comprise contacting a first major surface of a second substrate with the dispensed molten composition. The second substrate may include any of the suitable substrates listed above, and in some cases is preferably a release liner.

In a sixth aspect, another method of printing a composition is provided. The method comprises:
a) heating and mixing an extrudable article to form a molten composition, the extrudable article comprising at least one polyurethane comprising hydroxyl groups and latent isocyanate groups in the form of uretdione groups, wherein the hydroxyl groups are present on a first polyurethane and the latent isocyanate groups are present on either the first polyurethane or a second polyurethane, wherein a ratio of the isocyanate groups to the hydroxyl groups is greater than 1.2:1; and
b) dispensing the molten composition through a nozzle onto a substrate.

The extrudable article is as described in detail above according to the first aspect. In some embodiments, the extrudable article has a form of a filament, a ribbon, a plurality of pellets, or a pumpable melt and the extrudable article is heated and mixed in an extruder. In alternate embodiments, the extrudable article has the form of a plurality of pellets or a pumpable melt and the extrudable article is heated and mixed in a drum unloader or a pail unloader.

The composition may be deposited onto substrates at useful thicknesses ranging from 5 micrometers to 10000 micrometers, 25 micrometers to 10000 micrometers, 100 micrometers to 5000 micrometers, or 250 micrometers to 1000 micrometers. Useful substrates can be of any nature and composition, and can be inorganic or organic. Representative examples of useful substrates include ceramics, siliceous substrates including glass, metal (e.g., aluminum or steel), natural and man-made stone, woven and nonwoven articles, polymeric materials, including thermoplastic and thermosets, (such as polymethyl (meth)acrylate, polycarbonate, polystyrene, styrene copolymers, such as styrene acrylonitrile copolymers, polyesters, polyethylene terephthalate), silicones, paints (such as those based on acrylic resins), powder coatings (such as polyurethane or hybrid powder coatings), and wood; and composites of the foregoing materials.

Referring to FIG. 6, a schematic cross-section of an article 600 is illustrated. The article 600 comprises a composition 612 (e.g., an adhesive) disposed on a first major surface 611 of a first substrate 610. The article 600 further comprises a first major surface 613 of a second substrate 614 in contact with (e.g., adhered to) the composition 612 disposed on the first substrate 610.

### Select Embodiments of the Disclosure

In a first embodiment, the present disclosure provides an extrudable article. The extrudable article comprises at least one polyurethane comprising hydroxyl groups and latent isocyanate groups in the form of uretdione groups, wherein the hydroxyl groups are present on a first polyurethane and the latent isocyanate groups are present on either the first polyurethane or a second polyurethane, wherein a ratio of the latent isocyanate groups to the hydroxyl groups is greater than 1.2:1.

In a second embodiment, the present disclosure provides an extrudable article according to the first embodiment, having a form of a filament, a ribbon, a plurality of pellets, or a pumpable melt.

In a third embodiment, the present disclosure provides an extrudable article according to the first embodiment or the second embodiment, having a form of a filament.

In a fourth embodiment, the present disclosure provides an extrudable article according to the second embodiment or the third embodiment, having a form of a core-sheath filament, wherein the core comprises the at least one polyurethane, the sheath comprises an ethylene copolymer or a polyolefin, and the sheath surrounds the core.

In a fifth embodiment, the present disclosure provides an extrudable article according to the fourth embodiment, wherein the core-sheath filament has a longest cross-sectional distance in a range of 1 to 20 millimeters.

In a sixth embodiment, the present disclosure provides an extrudable article according to the fourth embodiment or the fifth embodiment, wherein the core-sheath filament comprises 1 to 15 weight percent sheath and 85 to 99 weight percent core based on a total weight of the core-sheath filament.

In a seventh embodiment, the present disclosure provides an extrudable article according to any of the fourth through sixth embodiments, wherein the core-sheath filament has an aspect ratio of length to longest cross-sectional distance of 50:1 or greater or 100:1 or greater.

In an eighth embodiment, the present disclosure provides an extrudable article according to any of the fourth through seventh embodiments, wherein the sheath further comprises an antiblock material.

In a ninth embodiment, the present disclosure provides an extrudable article according to any of the third through eighth embodiments, wherein the filament or the ribbon is wound on a spool.

In a tenth embodiment, the present disclosure provides an extrudable article according to any of the third through eighth embodiments, wherein the filament or the ribbon is provided as a festoon.

In an eleventh embodiment, the present disclosure provides an extrudable article according to any of the first through tenth embodiments, wherein a ratio of the latent isocyanate groups to the hydroxyl groups is 1.25:1 or greater, 1.3:1 or greater, 1.4:1 or greater, 1.5:1 or greater, 1.6:1 or greater, 1.7:1 or greater, 1.8:1 or greater, or 1.9:1 or greater; and 3.0:1 or less, 2.9:1 or less, 2.8:1 or less, 2.7:1 or less, 2.6:1 or less, 2.5:1 or less, 2.4:1 or less, 2.3:1 or less, 2.2:1 or less, 2.1:1 or less, or 2.0:1 or less.

In a twelfth embodiment, the present disclosure provides an extrudable article according to any of the first through eleventh embodiments, wherein the at least one polyurethane has a latent isocyanate group content of 0.20 to 0.70 equivalents per kilogram.

In a thirteenth embodiment, the present disclosure provides an extrudable article according to any of the first through twelfth embodiments, wherein the at least one polyurethane has a hydroxyl group content of 0.15 to 0.35 equivalents per kilogram.

In a fourteenth embodiment, the present disclosure provides an extrudable article according to any of the first through thirteenth embodiments, wherein the at least one polyurethane comprises a reaction product of a polymerizable composition comprising:
a) a uretdione-containing material comprising a reaction product of a diisocyanate reacted with itself;
b) a hydroxyl-containing compound; and
c) an isocyanate-containing compound.

In a fifteenth embodiment, the present disclosure provides an extrudable article according to the fourteenth embodiment, wherein at least one of the uretdione-containing material or the isocyanate-containing material comprises an aliphatic material and/or an aromatic material.

In a sixteenth embodiment, the present disclosure provides an extrudable article according to the fourteenth embodiment or the fifteenth embodiment, wherein the isocyanate-containing compound has two or more isocyanate groups.

In a seventeenth embodiment, the present disclosure provides an extrudable article according to any of the fourteenth through sixteenth embodiments, wherein the hydroxyl-containing compound comprises a polyester polyol.

In an eighteenth embodiment, the present disclosure provides an extrudable article according to the seventeenth embodiment, wherein the polyester polyol has a number average molecular weight (Mn) of 1,000 grams per mole (g/mol) to 6,000 g/mol or 3,000 g/mol to 4,000 g/mol.

In a nineteenth embodiment, the present disclosure provides an extrudable article according to the seventeenth embodiment or the eighteenth embodiment, wherein the polyester polyol comprises at least one of an adipate or a polycaprolactone.

In a twentieth embodiment, the present disclosure provides an extrudable article according to any of the fourteenth through nineteenth embodiments, wherein the hydroxyl-containing compound has two or more OH groups.

In a twenty-first embodiment, the present disclosure provides an extrudable article according to any of the fourteenth through twentieth embodiments, wherein the hydroxyl-containing compound has greater than 2.0 OH groups to 6.0 OH groups.

In a twenty-second embodiment, the present disclosure provides an extrudable article according to the twentieth embodiment or the twenty-first embodiment, wherein the polymerizable composition further comprises a monofunctional alcohol.

In a twenty-third embodiment, the present disclosure provides an extrudable article according to any of the fourteenth through nineteenth embodiments, wherein the hydroxyl-containing compound has only one OH group.

In a twenty-fourth embodiment, the present disclosure provides an extrudable article according to any of the fourteenth through twenty-third embodiments, wherein the polymerizable composition further comprises an organometallic catalyst and/or an amine catalyst.

In a twenty-fifth embodiment, the present disclosure provides an extrudable article according to any of the first through twenty-fourth embodiments, wherein the polyurethane has a weight average molecular weight (Mw) of 5,000 g/mol or greater.

In a twenty-sixth embodiment, the present disclosure provides an extrudable article according to any of the first through twenty-fifth embodiments, hermetically sealed in a package.

In a twenty-seventh embodiment, the present disclosure provides an extrudable article according to the twenty-sixth embodiment, further comprising a desiccant present in the package or as a component of the package.

In a twenty-eighth embodiment, the present disclosure provides a composition. The composition comprises at least one polyurethane comprising hydroxyl groups and latent isocyanate groups in the form of uretdione groups, wherein the hydroxyl groups are present on a first polyurethane and the latent isocyanate groups are present on either the first polyurethane or a second polyurethane, wherein a ratio of the latent isocyanate groups to the hydroxyl groups is greater than 1.2:1.

In a twenty-ninth embodiment, the present disclosure provides a composition according to the twenty-eighth embodiment, wherein a ratio of the latent isocyanate groups to the hydroxyl groups is 1.25:1 or greater, 1.3:1 or greater, 1.4:1 or greater, 1.5:1 or greater, 1.6:1 or greater, 1.7:1 or greater, 1.8:1 or greater, or 1.9:1 or greater; and 3.0:1 or less, 2.9:1 or less, 2.8:1 or less, 2.7:1 or less, 2.6:1 or less, 2.5:1 or less, 2.4:1 or less, 2.3:1 or less, 2.2:1 or less, 2.1:1 or less, or 2.0:1 or less.

In a thirtieth embodiment, the present disclosure provides a composition according to the twenty-eighth embodiment or the twenty-ninth embodiment, wherein the at least one polyurethane has a latent isocyanate group content of 0.20 to 0.70 equivalents per kilogram.

In a thirty-first embodiment, the present disclosure provides a composition according to any of the twenty-eighth through thirtieth embodiments, wherein the at least one polyurethane has a hydroxyl group content of 0.15 to 0.35 equivalents per kilogram.

In a thirty-second embodiment, the present disclosure provides a composition according to any of the twenty-eighth through thirty-first embodiments, wherein the at least one polyurethane comprises a reaction product of a polymerizable composition comprising:
a) a uretdione-containing material comprising a reaction product of a diisocyanate reacted with itself,
b) a hydroxyl-containing compound; and
c) an isocyanate-containing compound.

In a thirty-third embodiment, the present disclosure provides a composition according to the thirty-second embodiment, wherein at least one of the uretdione-containing material or the isocyanate-containing compound comprises an aliphatic material and/or an aromatic material.

In a thirty-fourth embodiment, the present disclosure provides a composition according to the thirty-second embodiment or thirty-third embodiment, wherein the isocyanate-containing compound has two or more isocyanate groups.

In a thirty-fifth embodiment, the present disclosure provides a composition according to any of the thirty-second through thirty-fourth embodiments, wherein the polymerizable composition comprises a polyester polyol.

In a thirty-sixth embodiment, the present disclosure provides a composition according to the thirty-fifth embodiment, wherein the polyester polyol has a number average molecular weight (Mn) of 1,000 grams per mole (g/mol) to 6,000 g/mol or 3,000 g/mol to 4,000 g/mol.

In a thirty-seventh embodiment, the present disclosure provides a composition according to the thirty-fifth embodiment or the thirty-sixth embodiment, wherein the polyester polyol comprises at least one of an adipate or a polycaprolactone.

In a thirty-eighth embodiment, the present disclosure provides a composition according to the thirty-seventh embodiment, wherein the polyester polyol comprises at least one of butylene adipate or hexamethylene adipate.

In a thirty-ninth embodiment, the present disclosure provides a composition according to any of the thirty-second through thirty-eighth embodiments, wherein the hydroxyl-containing compound has two or more OH groups.

In a fortieth embodiment, the present disclosure provides a composition according to any of the thirty-second through thirty-ninth embodiments, wherein the hydroxyl-containing compound has greater than 2.0 OH groups to 6.0 OH groups.

In a forty-first embodiment, the present disclosure provides a composition according to the thirty-ninth embodiment or the fortieth embodiment, wherein the polymerizable composition further comprises a monofunctional alcohol.

In a forty-second embodiment, the present disclosure provides a composition according to any of the thirty-second through thirty-eighth embodiments, wherein the hydroxyl-containing compound has only one OH group.

In a forty-third embodiment, the present disclosure provides a composition according to any of the thirty-second through forty-second embodiments, wherein the polymerizable composition further comprises an organometallic catalyst and/or an amine catalyst.

In a forty-fourth embodiment, the present disclosure provides a composition according to any of the thirty-second through forty-third embodiments, wherein the polyurethane has a weight average molecular weight (Mw) of 5,000 g/mol or greater.

In a forty-fifth embodiment, the present disclosure provides a method of making a core-sheath filament. The method comprises:
a) forming a core composition comprising at least one polyurethane comprising hydroxyl groups and latent isocyanate groups in the form of uretdione groups, wherein the hydroxyl groups are present on a first polyurethane and the latent isocyanate groups are present on either the first polyurethane or a second polyurethane, wherein a ratio of the latent isocyanate groups to the hydroxyl groups is greater than 1.2:1;
b) forming a sheath composition comprising an ethylene copolymer or a polyolefin; and
c) wrapping the sheath composition around the core composition to provide the core-sheath filament.

In a forty-sixth embodiment, the present disclosure provides a method according to the forty-fifth embodiment, wherein the wrapping the sheath composition around the core composition comprises co-extruding the core composition and the sheath composition such that the sheath composition surrounds the core composition.

In a forty-seventh embodiment, the present disclosure provides a method according to the forty-fifth embodiment or the forty-sixth embodiment, wherein the core-filament comprises 85 to 99 weight percent core and 1 to 15 weight percent sheath based on a total weight of the core-sheath filament.

In a forty-eighth embodiment, the present disclosure provides a method of making an extrudable article. The method comprises reacting in an extruder a polymerizable composition comprising:
i) a uretdione-containing material comprising a reaction product of a diisocyanate reacted with itself,
ii) a hydroxyl-containing compound; and
iii) an isocyanate-containing compound.

The extrudable article comprises at least one polyurethane comprising hydroxyl groups and latent isocyanate groups in the form of uretdione groups, wherein the hydroxyl groups are present on a first polyurethane and the latent isocyanate groups are present on either the first polyurethane or a second polyurethane, wherein a ratio of the latent isocyanate groups to the hydroxyl groups is greater than 1.2:1.

In a forty-ninth embodiment, the present disclosure provides a method according to the forty-eighth embodiment, the extrudable article having a form of a filament, a ribbon, a plurality of pellets, or a pumpable melt.

In a fiftieth embodiment, the present disclosure provides a method according to the forty-eighth embodiment or the forty-ninth embodiment, wherein the extrudable article has a form of a filament.

In a fifty-first embodiment, the present disclosure provides a method of printing a composition. The method comprises:
a) feeding an extrudable article to an extruder, the extrudable article comprising at least one polyurethane comprising hydroxyl groups and latent isocyanate groups in the form of uretdione groups, wherein the hydroxyl groups are present on a first polyurethane and the latent isocyanate groups are present on either the first polyurethane or a second polyurethane, wherein a ratio of the isocyanate groups to the hydroxyl groups is greater than 1.2:1;
b) heating and mixing the extrudable article in the extruder to form a molten composition; and
c) dispensing the molten composition through a nozzle of the extruder onto a substrate.

In a fifty-second embodiment, the present disclosure provides a method according to the fifty-first embodiment, wherein the extrudable article has a form of a filament, a ribbon, a plurality of pellets, or a pumpable melt.

In a fifty-third embodiment, the present disclosure provides a method according to the fifty-first embodiment or the fifty-second embodiment, wherein the extrudable article is a core-sheath filament according to any one of the forty-fifth through forty-seventh embodiments.

In a fifty-fourth embodiment, the present disclosure provides a method according to the fifty-first embodiment or the fifty-second embodiment, wherein the extrudable article has the form of a plurality of pellets or a pumpable melt and is fed to the extruder using a drum unloader or a pail unloader.

In a fifty-fifth embodiment, the present disclosure provides a method according to any of the fifty-first through fifty-fourth embodiments, wherein the substrate comprises a release liner.

In a fifty-sixth embodiment, the present disclosure provides a method according to any of the fifty-first through fifty-fifth embodiments, wherein the extruder is operated at a temperature of greater than 375° F. (190.6° C.) or greater than 400° F. (204.4° C.).

In a fifty-seventh embodiment, the present disclosure provides a method according to any of the fifty-first through fifty-sixth embodiments, wherein the nozzle of the extruder is operated at a temperature of greater than 375° F. (190.6° C.) or greater than 400° F. (204.4° C.).

In a fifty-eighth embodiment, the present disclosure provides a method according to any of the fifty-first through fifty-seventh embodiments, wherein the molten composition comprises a polyurethane having a weight average molecular weight (Mw) of 5,000 g/mol to 150,000 g/mol.

In a fifty-ninth embodiment, the present disclosure provides a method according to any of the fifty-first through fifty-eighth embodiments, wherein the molten composition comprises a branched polyurethane.

In a sixtieth embodiment, the present disclosure provides a method according to any of the fifty-first through fifty-ninth embodiments, wherein the molten composition comprises a polyurethane having an average isocyanate functionality of greater than 2.0.

In a sixty-first embodiment, the present disclosure provides a method according to any of the fifty-first through sixtieth embodiments, wherein the molten composition exhibits a complex viscosity of 50 to 15,000 pascal·seconds, using oscillatory shear at 1.0 rad/s and 1.0% strain at a temperature of 210° C.

In a sixty-second embodiment, the present disclosure provides a method according to any of the fifty-first through sixty-first embodiments, further comprising contacting a first major surface of a second substrate with the dispensed molten composition.

In a sixty-third embodiment, the present disclosure provides a method according to the sixty-second embodiment, wherein the second substrate comprises a release liner.

In a sixty-fourth embodiment, the present disclosure provides a method according to the sixty-second embodiment, wherein the composition is an adhesive that exhibits a minimum overlap shear on aluminum of 1.0 megaPascals (MPa).

In a sixty-fifth embodiment, the present disclosure provides a method of printing a composition. The method comprises:
a) heating and mixing an extrudable article to form a molten composition, the extrudable article comprising at least one polyurethane comprising hydroxyl groups and latent isocyanate groups in the form of uretdione groups, wherein the hydroxyl groups are present on a first polyurethane and the latent isocyanate groups are present on either the first polyurethane or a second polyurethane, wherein a ratio of the isocyanate groups to the hydroxyl groups is greater than 1.2:1; and
b) dispensing the molten composition through a nozzle onto a substrate.

In a sixty-sixth embodiment, the present disclosure provides a method according to the sixty-fifth embodiment, wherein the extrudable article has a form of a filament, a ribbon, a plurality of pellets, or a pumpable melt and the extrudable article is heated and mixed in an extruder.

In a sixty-seventh embodiment, the present disclosure provides a method according to the sixty-fifth embodiment or the sixty-sixth embodiment, wherein the extrudable article has the form of a plurality of pellets or a pumpable melt and the extrudable article is heated and mixed in a drum unloader or a pail unloader.

### EXAMPLES

Unless otherwise noted or readily apparent from the context, all parts, percentages, ratios, etc. in the Examples and the rest of the specification are by weight. Table 1 (below) lists materials used in the examples and their sources. In the Tables, “NA” means not applicable. In the examples: EX—designates working examples, CEX—designates comparative examples, and PEX—designates preparative examples.

TABLE 1
Materials List

| DESIGNATION | DESCRIPTION | SOURCE |
|---|---|---|
| 105P-30 | Polyhexamethylene adipate with a hydroxyl | Stepan Company, |
| | number of 30, obtained under the trade | Northfield, IL |
| | designation “STEPANPOL PC 105P-30” | |
| 44-111 | Polybutylene adipate with a hydroxyl number | Lanxess, Cologne, |
| | of 111, obtained under the trade designation | Germany |
| | “FOMREZ 44-111” | |
| 1,4-BDO | 1,4-Butanediol | Sigma-Aldrich Co., |
| | | St. Louis, MO |
| CA3031 | Liquid triol with a hydroxyl number of 560, | Ingevity, North |
| | obtained under the trade designation “CAPA | Charleston, SC |
| | 3031” | |
| 2-EHOH | 2-ethylhexanol | Sigma-Aldrich |
| RUB1234 | A methylene diphenyl diisocyanate (MDI) | Huntsman |
| | prepolymer with 38% ethylene-co-butylene | Corporation, The |
| | adipate, obtained under the trade designation | Woodlands, TX |
| | “RUBINATE 1234” | |
| DBTDL | Dibutyltin dilaurate | Sigma-Aldrich |
| EF403 | Cycloaliphatic polyuretdione with an NCO | Covestro, |
| | content of 13.5%, obtained under the trade | Leverkusen, |
| | designation “CRELAN EF 403” | Germany |
| N3400 | A uretdione-containing polyisocyanate based on | Covestro |
| | hexamethylene diisocyanate (HDI) with 22% | |
| | unblocked isocyanate and 16% isocyanate in the | |
| | form of uretdione, obtained under the trade | |
| | designation “DESMODUR N 3400” | |
| E280PV | A random copolymer of ethylene and vinyl | Hanwha Solutions, |
| | acetate with 28 wt. % vinyl acetate, obtained | Seoul, South Korea |
| | under the trade designation “E280PV” | |
| NA217000 | Low Density Polyethylene with a Melt Flow | LyondellBasell, |
| | Rate of 5.6 g/10 min | Rotterdam, |
| | | Netherlands |
| EF546 | EVA Copolymer with 6% vinyl acetate | Westlake Chemical, |
| | | Houston, TX |

### Test Methods

### NMR Analysis of EF403

CRELAN EF 403 was dissolved in deuterated dimethyl sulfoxide (DMSO) solvent. The ¹H NMR spectrum was taken with a 500 MHz NMR (AVANCE III 500 MHz spectrometer equipped with a broadband cryoprobe from Bruker, Billerica, Massachusetts). NMR analysis of CRELAN EF 403 shows it to be composed of isophorone diisocyanate (IPDI), polycaprolactone, 1,4-butanediol, and 2-ethylhexanol. For purposes of mathematical modeling, the composition of CRELAN EF 403 was approximated as 64 wt. % IPDI dimer, 5 wt. % 2-EHOH, 5 wt. % 1,4-BDO, and 26 wt. % 1,4-BDO-initiated polycaprolactone with an average molecular weight of 400 g/mol.

### NMR Analysis of N3400

N3400 was dissolved in deuterated dimethyl sulfoxide (DMSO) solvent. The ¹H NMR spectrum was taken with a 500 MHz NMR (AVANCE III 500 MHz spectrometer equipped with a broadband cryoprobe from Bruker, Billerica, Massachusetts). The resulting spectrum had 5 major signals. Signals at 1.31 parts per million (ppm) and 1.55 ppm were attributed to methylene groups at the 3 and 4 positions and the 2 and 5 positions of the HDI derivatives, respectively. A signal at 3.17 ppm was attributed to methylene protons adjacent to a uretdione group. A signal at 3.34 ppm was attributed to methylene protons adjacent to an isocyanate group. A signal at 3.74 ppm was attributed to methylene protons adjacent to an isocyanurate group. The published values for N3400 are an equivalent weight of isocyanate of 193 g/equivalent and 22 weight percent isocyanate. The ratio of the integration of the signal at 3.17 ppm over the integration of the signal at 3.34 ppm is 0.75, which corresponds to 16 wt. % uretdione. The functionality of N3400 is published as 2.5 (in “Raw Materials for Automotive Refinish Systems” from Bayer Materials Science, 2005), so the number average molecular weight of the molecule in N3400 is 193 grams/equivalent×2.5 equivalents/mole=482 grams/mol. For molecular weight calculations, the overall composition of N3400 was approximated as 33 wt. % HDI dimer with a uretdione groups, 10 wt. % HDI trimer with two uretdione groups, 19 wt. % HDI trimer with one isocyanurate group, and 38 wt. % HDI tetramer with one uretdione group and one isocyanurate group. After heating to revert uretdione to isocyanate, the composition is approximated as 52.5 wt. % HDI monomer and 47.5 wt. % HDI trimer with an isocyanurate group.

### Calculated Molecular Weights

The weight average molecular weight (Mw) can be calculated using the method described in Macromolecules, Vol. 9, No. 2, pages 199-206 (1976). Within that reference, one case describes step-growth co-polymerizations with arbitrary functional groups of type A that react with arbitrary functional groups of type B. In this case, Mw can be calculated by the equation

$${M}_{W} = \frac{{p}_{B} {m}_{a}^{′} + {p}_{A} {m}_{b}^{′}}{{p}_{B} {m}_{a} + {p}_{A} {m}_{b}} + \frac{{p}_{A} {p}_{B} [ {p}_{A} ( {f}_{e} - 1 ) {M}_{b}^{2} + {p}_{B} ( {g}_{e} - 1 ) {M}_{a}^{2} + 2 {M}_{a} {M}_{b} ]}{( {p}_{B} {m}_{a} + {p}_{A} {m}_{b} ) [ 1 - {p}_{A} {p}_{B} ( {f}_{e} - 1 ) ( {g}_{e} - 1 ) ]}$$

which is equation 39 in the reference. In this equation, p_{A} is the probability that a functional group of type A has reacted, p_{B} is the probability that a functional group of type B has reacted, and

$${m}_{a} = {\sum }_{i} {M}_{{A}_{fi}} {a}_{{f}_{i}} / {f}_{i}$$

$${m}_{a}^{′} = {\sum }_{i} {M}_{{A}_{fi}}^{2} {a}_{{f}_{i}} / {f}_{i}$$

$${m}_{b} = {\sum }_{j} {M}_{{B}_{gj}} {b}_{{g}_{j}} / {g}_{j}$$

$${m}_{b}^{′} = {\sum }_{j} {M}_{{B}_{gj}}^{2} {b}_{{g}_{j}} / {g}_{j}$$

$${f}_{e} = {\sum }_{i} {f}_{i} {a}_{{f}_{i}}$$

$${g}_{e} = {\sum }_{j} {g}_{j} {b}_{{g}_{j}}$$

$${M}_{a} = {\sum }_{i} {M}_{{A}_{fi}} {a}_{{f}_{i}}$$

$${M}_{b} = {\sum }_{j} {M}_{{B}_{gj}} {b}_{{g}_{j}}$$

$${a}_{{f}_{i}} = \frac{{f}_{i} {A}_{{f}_{i}}}{{\sum }_{i} {f}_{i} {A}_{fi}}$$

$${b}_{{g}_{j}} = \frac{{g}_{j} {B}_{{g}_{j}}}{{\sum }_{j} {g}_{j} {B}_{{g}_{j}}}$$

where M_{Af} is the molecular weight of a monomer with f functional groups of type A, M_{Bg} is the molecular weight of a monomer with g functional groups of type B, Af is the number of moles of monomer with f functional groups of type A, and B_{g} is the number of moles of monomer with g functional groups of type B. In all cases, the calculations reflect reactions that have proceeded to completion (i.e., either p_{A} or p_{B} has reached a value of one).

For blends of EF403 with other urethane polymers, calculations were performed to account for the EF403 being not reactive with the other urethane component until after sufficient heat is applied to revert the uretdione groups in EF403 to isocyanate. Therefore, the Mw of these blends before uretdione reversion is the weighted average of the Mw of the EF403 (18,000 g/mol) and the Mw of the other urethane. After the uretdione reversion, reaction between the EF403 and the other urethane is accounted for, and the molecular weight is the weight resulting from the reaction of the components of the EF403 with the components of the other urethane.

### Viscosity Measurement Test Method

Complex viscosity was measured using a DHR2 Rheometer from TA Instruments (New Castle, DE) equipped with 8 millimeter (mm) stainless steel parallel plates. The plates were heated to 150° C., and a sample of excess urethane was then pressed on the plates to thickness of 1.2 mm. The excess urethane that was outside the gap between the plates was removed. The plates were then closed further to a gap of 1.0 mm. The sample was then tested with oscillatory shear at 1.0 rad/second and 1.0% strain while the temperature was ramped at a rate of 2.0° C./minute from 150° C. to 240° C. The complex viscosity that was measured at 210° C. is reported as the melt viscosity.

### Overlap Shear Test Method

The performance of the adhesives described above was determined using overlap shear tests. Aluminum coupons (1 inch×4 inches×0.062 inch (2.54 cm×10.16 cm×0.16 cm)) were sanded with 220 grit sandpaper and wiped with isopropanol. The resulting molten polyurethane adhesive was dispensed from a rectangular nozzle tip with a 12.5 mm by 1 mm orifice directly onto the aluminum coupons. The mixture was then applied to a roughly 1 inch×0.5 inch (2.54 cm×1.27 cm) area on one end of the aluminum coupon. One end of a second aluminum coupon was then pressed into the mixture to produce an overlap of approximately 0.5 inch (1.27 cm). The materials were allowed to cure for a specified time below before testing. The samples were tested to failure in shear mode at a rate of 2 inch/minute (5.1 cm/minute) using a tensile load frame with self-tightening grips (MTS Systems, Eden Prairie, MN). After failure, the length of the overlap area was measured. The overlap shear value was then calculated by dividing the peak load by the overlap area.

### General Filament Dispensing Method

A portion of a filament sample was fed into a dispense head assembly similar to that described in PCT Patent Publication WO 2020/174394 (Napierala et al.) and set to a stock temperature of 410° F. (210° C.). The resulting molten polyurethane adhesive was dispensed from a rectangular nozzle tip with a 12.5 mm by 1 mm orifice directly onto aluminum substrates from a nominally 2 mm height. At this point, Fourier Transform Infrared spectroscopy (FTIR) showed the loss of the shoulder at 1760 cm⁻¹ and the appearance of a peak at 2250 cm⁻¹ consistent with isocyanate functional groups.

### Karl Fischer Titration Method

A sample of filament (0.3 grams to 0.6 grams) was placed in a 6 mL glass vial (Part 6.2419.007 from Metrohm, Herisau, Switzerland) and an aluminum septum cap (Part 5183-4477 from Agilent Technologies, Inc. Santa Clara, CA) was crimped to seal the vial. The vial was placed in an oven (860 KF Thermoprep from Metrohm) set at 150° C. Dry air was passed through the vial's headspace at 75 mL/min into a Karl Fischer titration cell (899 Coulometer from Metrohm) and bubbled into the analyte solution (Hydranal Coulomat AG-Oven from Honeywell International Inc. Charlotte, NC). Titration parameters were set with Start Drift=20 ug/min, Extraction time=180 s, and Stirring rate=12, and titration was conducted until the endpoint was reached. An equivalent empty vial was analyzed as a blank sample. The measured water from the blank was subtracted from the measured water from the sample, and that corrected water content was divided by the sample weight to give the water concentration in the sample.

### EXAMPLES

### Example 1 (Ex-1): Filament without Sheath

The formulation shown in Table 2 was fed into a co-rotating twin screw extruder and allowed to react at a temperature between 80-150° C. The formulation was discharged to a gear pump (Zenith PEP II with 3.0 cm³/revolution). The pump metered the polymer through a 6 foot (1.8 meter (m)) long PTFE lined heated hose to a circular nozzle. The resulting polymer melt was pulled through a 2-meter water bath at 5° C. as a filament with a diameter of 8 mm. The filament was pulled into a belt puller from Killion Extruders (Riviera Beach, FL), model number 2-12 and then spooled into a bucket. FTIR analysis of the resulting filament showed a pronounced shoulder at 1770 cm⁻¹ consistent with uretdione functional groups.

The resulting filament was then subjected to the General Filament Dispense Method. After 7 days, the samples were tested for overlap shear strength and gave an average value of 6.3 MPa.

### Examples 2, 5, 6, 7, and 8 (Ex-2, Ex-5, Ex-6, Ex-7, and Ex-8)

The formulations shown in Table 2 were fed into a co-rotating twin screw extruder and allowed to react at a temperature between 80-150° C. The resulting polymer melt was extruded through a Multilayer Overcoat Die from Joe Tools (Lilburn, GA) (model number XML*70*50257-01 9/32×5/8 Crosshead) to generate a urethane adhesive core. A Single Screw Extruder (30 mm Killion Extruders with a 3:1 compression screw) was used to melt and extrude E280PV. The E280PV was extruded into a sheath layer in the multilayer overcoat die to make a 2-layer filament with a urethane adhesive core and a 4 wt. % EVA sheath. The core-sheath extrudate was cooled in a water bath as a filament with a diameter of 8 mm. For all Examples produced with this method, FTIR analysis of the exterior surface of the resulting filament was consistent with EVA, and the analysis of the core cross section showed a pronounced shoulder at 1770 cm⁻¹ consistent with uretdione functional groups.

The resulting filaments from Example 2, Example 5, and Example 6 were subjected to the General Filament Dispense Method. After 7 days, the samples were tested for overlap shear strength and gave average values of 6.5 MPa for Example 2, 4.7 MPa for Example 5, and 5.0 MPa for Example 6.

### Example 3 (Ex-3)

105P-30 (156.0 g), 44-111 (58.8 g), and EF403 (78.9 g) were mixed at 80° C. until the EF403 dissolved. A 44 gram portion of this premix was combined with 1,4-BDO (1.42 g), CA3031 (1.54 g), DBTDL (0.009 g), and RUB1234 (13.0 g) and mixed with a Flacktek Speed Mixer (Landrum, SC) for 30 seconds. This formulation was then deposited onto a silicone-coated polyester film. A second silicone-coated polyester film was placed over the reactive mixture such that the thickness of the reactive mixture was 2-5 mm. This was placed in an oven set at 100° C. and allowed to cure for 30 minutes. The sample was removed from the oven and the top film was removed. While still warm, the polyurethane sheet was rolled into a rod shape. FTIR analysis of the resulting filament showed a pronounced shoulder at 1770 cm⁻¹ consistent with uretdione functional groups.

A 17 gram portion of this filament was then fed into an Xplore MC-15 microcompounder (Xplore, Sittard, the Netherlands) at 200° C. This sample was mixed in the microcompounder for three minutes and then deposited onto aluminum coupons. At this point, FTIR showed the loss of the shoulder at 1760 cm⁻¹ and the appearance of a peak at 2250 cm⁻¹ consistent with isocyanate functional groups. After 7 days, the samples were tested for overlap shear strength and gave an average value of 4.6 MPa.

### Example 4 (Ex-4)

The formulation in Table 2 was added to a plastic cup at a scale of 40 g total material and mixed for 10 seconds with a speed mixer. A portion of this reactive mixture (15 milliliters (mL)) was added to an MC-15 microcompounder and mixed for 5 minutes at 150° C. This material was then deposited onto a polytetrafluoroethylene (PTFE) sheet and cooled to make a filament. FTIR analysis of the resulting filament showed a pronounced shoulder at 1760 cm⁻¹ consistent with uretdione functional groups.

17 gram portions of multiple replicates of this filament were then fed into an Explore MC-15 microcompounder at 200° C. Each sample was mixed in the microcompounder for three minutes and then deposited onto an aluminum coupon. At this point, FTIR showed the loss of the shoulder at 1770 cm⁻¹ and the appearance of a peak at 2250 cm⁻¹ consistent with isocyanate functional groups. After 7 days, the samples were tested for overlap shear strength and gave an average value of 3.4 MPa.

TABLE 2
Formulations for Examples 1 to 8

| | EX-1 and | | | | | | |
|---|---|---|---|---|---|---|---|
| | EX-2 | EX-3 | EX-4 | EX-5 | EX-6 | EX-7 | EX-8 |
| 105P-30, wt. % | 39.6 | 39 | 26 | 38.8 | 42.9 | 38.3 | 39.3 |
| 44-111, wt. % | 14.9 | 14.7 | 31 | 14.8 | 14.8 | 14.8 | 14.8 |
| 1,4-BDO, wt. % | 2.4 | 2.4 | 3.5 | 2.4 | 1.6 | 2.3 | 2.4 |
| CA3031, wt. % | 1.2 | 2.6 | — | 2.6 | 2.6 | 2.6 | 2.6 |
| 2-EHOH, wt. % | — | — | 5.3 | — | — | — | — |
| DBTDL, wt. % | 0.02 | 0.01 | — | 0.02 | 0.02 | 0.02 | 0.02 |
| RUB1234, wt. % | 21.9 | 21.6 | 17.1 | 22.3 | 18.1 | 22.1 | 22.4 |
| EF403, wt. % | 20 | 19.7 | — | 19.3 | 20 | 20 | 18.5 |
| N3400, wt. % | — | — | 17.1 | — | — | — | — |
| OH, equiv/kg | 0.17 | 0.31 | 0.29 | 0.28 | 0.31 | 0.28 | 0.28 |
| UD, equiv/kg | 0.65 | 0.64 | 0.67 | 0.62 | 0.65 | 0.65 | 0.6 |
| Mw, g/mol Before | 39,000 | 24,000 | 19,000 | 20,000 | 25,000 | 36,000 | 28,000 |
| Mw, g/mol After | 13,000 | 54,000 | 11,000 | 75,000 | 47,000 | 35,000 | 47,000 |
| Melt Viscosity, | 80 | 3100 | 11,800 | 3000 | 5900 | 4600 | 5400 |
| Pa*s | | | | | | | |

### Examples 9, 10, 11, 12, and 13 (Ex-9, Ex-10, Ex-11, Ex-12, and Ex-13)

A formulation of 105P-30 (46.9 wt. %), 44-111 (9.0 wt. %), 1,4-BDO (4.1 wt. %), CA3031 (0.6 wt. %), DBTDL (0.015 wt. %), RUB1234 (27.4 wt. %) and EF403 (12 wt. %) was fed into a co-rotating twin screw extruder and allowed to react at a temperature between 80-150° C. The resulting polymer melt was extruded through a Multilayer Overcoat Die from Joe Tools (Lilburn, GA) (model number XML*70*50257-01 9/32×5/8 Crosshead) to generate a urethane adhesive core. A Single Screw Extruder (30 mm Killion Extruders with a 3:1 compression screw) was used to melt and extrude sheath materials as shown in Table 3. The core-sheath extrudate was cooled in a water bath as a filament with a diameter of 8 mm, and excess water was blown from the surface of the filaments with a series of four air wipes (each Model 2451 from EXAIR Corporation, Cincinnati, OH). The filaments were sealed into metal pails. After six days, samples were removed from the pails and analyzed for water content using the Karl Fischer Titration Method. The measured moisture content is shown in Table 3. For all Examples produced with this method, FTIR analysis of the exterior surface of the resulting filament was consistent with EVA or LDPE, and the analysis of the core cross section showed a pronounced shoulder at 1770 cm⁻¹ consistent with uretdione functional groups. The resulting filaments from Example 9, Example 10, Example 11, and Example 12 were subjected to the General Filament Dispense Method, and the resulting values are shown in Table 3.

TABLE 3
Examples 9 to 13 with Variations in Sheath Content

| | Ex-9 | | Ex-10 | | Ex-11 | | Ex-12 | | Ex-13 | |
|---|---|---|---|---|---|---|---|---|---|---|
| Sheath Material | NA217000 | | NA217000 | | NA217000 | | EF546 | | E280PV | |
| Sheath Wt. Fraction | 4 | wt. % | 8 | wt. % | 12 | wt. % | 12 | wt. % | 12 | wt. % |
| Measured Moisture | 150 | ppm | 80 | ppm | 0 | ppm | 160 | ppm | 570 | ppm |

| | | | | | | | | | |
|---|---|---|---|---|---|---|---|---|---|
| Overlap Shear | 3.3 | MPa | 4.2 | MPa | 4.0 | MPa | 4.1 | MPa | Not Tested |

Strength

Other modifications and variations to the present disclosure may be practiced by those of ordinary skill in the art, without departing from the spirit and scope of the present disclosure, which is more particularly set forth in the appended claims. It is understood that aspects of the various embodiments may be interchanged in whole or part or combined with other aspects of the various embodiments. All cited references, patents, or patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. An extrudable article comprising at least one polyurethane comprising hydroxyl groups and latent isocyanate groups in the form of uretdione groups, wherein the hydroxyl groups are present on a first polyurethane and the latent isocyanate groups are present on either the first polyurethane or a second polyurethane, wherein a ratio of equivalents of the latent isocyanate groups to equivalents of the hydroxyl groups is greater than 1.2:1, wherein the at least one polyurethane is curable by reverting the uretdione groups to isocyanate groups upon heating, followed by reaction of the isocyanate groups with ambient moisture.

2. The extrudable article of claim 1, having a form of a filament, a ribbon, a plurality of pellets, or a pumpable melt.

3. The extrudable article of claim 2, having a form of a core-sheath filament, wherein the core comprises the at least one polyurethane, the sheath comprises an ethylene copolymer or a polyolefin, and the sheath surrounds the core.

4. The extrudable article of claim 3, wherein the sheath further comprises an antiblock material.

5. The extrudable article of claim 1, wherein the at least one polyurethane comprises a reaction product of a polymerizable composition comprising:
a) a uretdione-containing material comprising a reaction product of a diisocyanate reacted with itself,
b) a hydroxyl-containing compound; and
c) an isocyanate-containing compound.

6. The extrudable article of claim 5, wherein the hydroxyl-containing compound comprises a polyester polyol having a number average molecular weight (Mn) of 1,000 grams per mole (g/mol) to 6,000 g/mol or 3,000 g/mol to 4,000 g/mol.

7. The extrudable article of claim 6, wherein the polyester polyol comprises at least one of an adipate or a polycaprolactone.

8. The extrudable article of claim 1, hermetically sealed in a package.

9. A composition comprising at least one polyurethane comprising hydroxyl groups and latent isocyanate groups in the form of uretdione groups, wherein the hydroxyl groups are present on a first polyurethane and the latent isocyanate groups are present on either the first polyurethane or a second polyurethane, wherein a ratio of equivalents of the latent isocyanate groups to equivalents of the hydroxyl groups is greater than 1.2:1, wherein the at least one polyurethane is curable by reverting the uretdione groups to isocyanate groups upon heating, followed by reaction of the isocyanate groups with ambient moisture.

10. The composition of claim 9, wherein the at least one polyurethane comprises a reaction product of a polymerizable composition comprising:
a) a uretdione-containing material comprising a reaction product of a diisocyanate reacted with itself,
b) a hydroxyl-containing compound; and
c) an isocyanate-containing compound.

11. (canceled)

12. (canceled)

13. A method of making a core-sheath filament, the method comprising:
a. forming a core composition comprising at least one polyurethane comprising hydroxyl groups and latent isocyanate groups in the form of uretdione groups, wherein the hydroxyl groups are present on a first polyurethane and the latent isocyanate groups are present on either the first polyurethane or a second polyurethane, wherein a ratio of equivalents of the latent isocyanate groups to equivalents of the hydroxyl groups is greater than 1.2:1;
b. forming a sheath composition comprising an ethylene copolymer or a polyolefin; and
c. wrapping the sheath composition around the core composition to provide the core-sheath filament.

14. The method of claim 13, wherein the wrapping the sheath composition around the core composition comprises co-extruding the core composition and the sheath composition such that the sheath composition surrounds the core composition.

15. The method of claim 13, wherein the core-filament comprises 85 to 99 weight percent core and 1 to 15 weight percent sheath based on a total weight of the core-sheath filament.

16-18. (canceled)

19. A method of printing a composition, the method comprising:
a) feeding an extrudable article to an extruder, the extrudable article comprising at least one polyurethane comprising hydroxyl groups and latent isocyanate groups in the form of uretdione groups, wherein the hydroxyl groups are present on a first polyurethane and the latent isocyanate groups are present on either the first polyurethane or a second polyurethane, wherein a ratio of equivalents of the isocyanate groups to equivalents of the hydroxyl groups is greater than 1.2:1;
b) heating and mixing the extrudable article in the extruder to form a molten composition; and
c) dispensing the molten composition through a nozzle of the extruder onto a substrate.

20. The method of claim 19, wherein the extrudable article is a core-sheath filament according to claim 13.

21. The method of claim 19, wherein the extruder is operated at a temperature of greater than 375° F. (190.6° C.) or greater than 400° F. (204.4° C.).

22. The method of claim 19, wherein the molten composition exhibits a complex viscosity of 50 to 15,000 pascal·seconds, using oscillatory shear at 1.0 rad/s and 1.0% strain at a temperature of 210° C.

23. The method of claim 19, further comprising contacting a first major surface of a second substrate with the dispensed molten composition.

24. The method of claim 23, wherein the composition is an adhesive that exhibits a minimum overlap shear strength on aluminum of 1.0 megaPascals (MPa).

25-27. (canceled)
